(19) United States
(12) Patent Application Publication
(10) Pub. No.: US 2009/0272781 A1
(43) Pub. Date: Nov. 5, 2009

(54) STAPLER

(75) Inventors: Jun Maemori, Tokyo (JP); Akira Aoki, Tokyo (JP)

Correspondence Address: DRINKER BIDDLE & REATH (DC), 1500 K STREET, N.W., SUITE 1100, WASHINGTON, DC, 20005-1209, US

(73) Assignee: Max Co., Ltd., Tokyo (JP)

(21) Appl. No.: 12/088,475

(22) PCT Filed: Nov. 14, 2006
(86) PCT No.: PCT/JP2006/323065

§ 371 Date: Mar. 28, 2008

(30) Foreign Application Priority Data
Nov. 18, 2005 (JP) 2005-333983
Nov. 18, 2005 (JP) 2005-333984
Nov. 22, 2005 (JP) 2005-337791
Dec. 16, 2005 (JP) 2005-363337

(51) Int. Cl. B25C 5/11

(52) U.S. Cl. 227/120

(57) ABSTRACT

A stapler has a handle formed in a U-shape and a driver unit that is attached to a front end of the handle and a magazine that stores staples therein. The driver unit includes a driver plate fixed to a front portion of a driver holder. A rear portion of the handle and a rear portion of the magazine are concentrically and pivotally connected. Arms, each protruding from respective sides of the driver holder, are movably inserted into respective engaging holes formed on each of the side plates of the handle. When the handle is initially pushed down, rear upper parts of the driver holder come in contact with an upper inner surface of the handle so that a leading end of the driver plate is inclined toward a front side of the magazine.

### TECHNICAL FIELD

The present invention relates to a stapler.

### BACKGROUND ART

There is known a stapler in which an outer handle and an inner handle have different pivots at the ends thereof and can rotate, respectively. The both handles are interlocked and connected to each other by a connecting member forming a power multiplying mechanism. A force-increasing effect caused by such interlock-connection structure reduces an operational force used to bind a bunch of papers (see, e.g., JP-A-2005-138248 (page 9, FIG. 15) and JP-A-2005-138247 (page 4, FIG. 15).

Although such staplers are a middle size or a large size stapler, it includes a driver plate provided to an inner handle, like a common stapler. Further, when the driver plate operates so as to pass through the front end portion of a magazine provided below the inner handle, the foremost staple of connected staples stored in the magazine is discharged to bind the bunch of papers.

In the middle size or large size stapler, staples having long legs are usually used, and thus, the driving stroke of the staple is long. Accordingly, the driver plate should be long. For this reason, according to the configuration in which the driver plate is fixed to the inner handle, when the driver plate discharges a staple (descend) and when the driver plate ascends (return), the driver plate is curved. Therefore, it is preferable that the driver plate be unitized and attached to the inner handle so as to freely move to some extent.

However, if a driver unit freely moves, when the driver plate discharges a staple, a driving angle of the driver plate is unstable. For this reason, the leading end of the driver plate deviates from a correct position, so that two staples, that is, the foremost staple and the next staple are simultaneously discharged. In addition, when the driver plate returns upward, sliding friction between the driver plate and the front wall of the magazine is increased. As a result, the driver plate is not easily separated from the magazine, so that the magazine is lifted together with the driver plate.

Meanwhile, not limited to a driver unit of the above-mentioned large size stapler, a driver unit including a driver holder and a driver plate that are integrally formed with each other by riveting is widely used. However, according to the above-mentioned driver unit, when the staple is driven, the reaction force of the driver plate is directly applied to a riveted portion. In particular, a rotation force is generated due to a non-uniform reaction force applied to the leading end of the driver plate, and causes the driver plate to rotate about the riveted portion in a left and right direction in front view of the driver plate. Further, the rotation force is directly applied to the riveted portion. Accordingly, when the driver unit is used for a long time, the riveted portion becomes loosed.

When the staple is driven, the looseness of the riveted portion causes the driver plate to become inclined. The inclination of the driver plate causes uneven distribution of the reaction force applied to the leading end of the driver plate. As a result the driver plate is inclined. The above-mentioned problems of the stapler do not generally occur in the stapler that includes a magazine having a relatively large height and a sufficiently long driver plate. However, the above-mentioned problems occasionally occur in a medium or large size stapler that includes a magazine having a relatively small height and a power multiplying mechanism used to bind the bunch of papers so as to strongly press a long driver plate.

As described above, the above-mentioned problems of the stapler causes the driver plate to become inclined due to the uneven distribution of the reaction force applied to the leading end of the driver plate, which is caused by the inclination of the driver plate, and prevents a staple driving force from being appropriately transmitted to the staple. For this reason, it is difficult to correctly drive the staple by using the driver plate and the bound portion of the bunch of papers is incompletely bound. As a result, it is not possible to provide the bound portion of the bunch of papers having an excellent appearance and shape.

Further, the inclination of the pressed driver plate causes the driver plate not to slide smoothly due to friction between a discharge portion and the driver plate. For this reason, there has been a problem in that the driver plate does not return appropriately. In addition, the inclination of the driver plate occasionally causes the driver plate and the driver holder to be damaged.

Furthermore, when the bunch of papers is bound by a large size stapler having a power multiplying mechanism in the related art, it is difficult to feel whether the staple is appropriately driven and to perceive whether the bunch of papers is completely bound. For this reason, an excessively strong force is applied to the stapler, so that the staple tends to be excessively driven into the bunch of papers.

In this case, as shown in FIG. 28, a driven staple S is buried into a bunch of papers 100 and swelling is caused by the bend of the bunch of papers 100, so that wrinkles W occur at the bound portion of the papers. In particular, when the bunch of paper is bound by using a staple, the above-mentioned phenomena are inevitable. The swelling of the bunch of papers 100, caused by the bend of the papers occurring at the bound portion, makes the appearance or shape worse, not only for the bunch of papers but also for the bound documents.

Moreover, the staple discharged from the discharge portion of the magazine penetrates the bunch of papers to be bound, and are then pressed against the clinch groove so as to be bent. Accordingly, the magazine should be positioned above the clinch groove with high accuracy. For this reason, a large size stapler generally has the following configuration. That is, a magazine guide having a U-shaped cross section is mounted on an upper surface of a base part in a longitudinal direction, a magazine is rotatably supported by one end of the magazine guide, and a clincher having a clinch groove is fixed on the other side of the magazine guide so as to correspond to a discharge portion formed at the end of the magazine. Further, in general, the clincher has been positioned on the magazine guide by using a jig, and then fixed to the magazine guide by a screw or riveting (see, e.g., JP-U-6-3573).

Since the large size stapler is used to bind many sheets of papers, it is necessary to set a binding position by aligning the end of the bunch of papers. For this reason, a positioning member called as a gauge is provided in the stapler so as to move on the base part in the longitudinal direction of the base part. Accordingly, the positioning member is stopped at a desired position so as to align the end of the bunch of papers.

In this case, a holding mechanism for holding the positioning member at a desired position needs to be provided so that the positioning member does not easily move. However, a sufficient holding force is not obtained by a holding mechanism in the related art. Accordingly, there has been considered a structure in which a base part is covered with a base cover part made of a synthetic resin and a deep scale groove is formed on the base cover part so as to reliably hold the positioning member.

However, when the clincher is positioned by using a jig, it takes a lot of time to assemble the jig. When a user unfastens a screw for fixing the clincher, it is difficult to fix the clincher at a correct position. For this reason, when a problem occurs in the clincher, the clincher should be sent to a store or a maker for repairs. Accordingly, this causes inconvenience to the user.

Further, the clincher is fixed on the magazine guide. Accordingly, in the case of the configuration where the base part is covered with the base cover part, there is a problem in that it is difficult to fix the clincher to the magazine guide. To solve the above-mentioned problem, there has been considered a structure in which openings are formed in the base cover part so as to check a clincher mounting position of the magazine. However, since the base cover should have a good appearance, the openings through which the magazine guide is exposed should be not formed in the base cover part for good appearance.

Furthermore, in the case of the configuration where the base part is covered with the base cover part, it is not possible to fix the clincher to the magazine guide by riveting.

### DISCLOSURE OF THE INVENTION

One or more embodiments of the present invention provides a stapler in which the above-mentioned problems are solved.

According to one or more embodiments of the invention, a stapler includes: a handle that includes an upper plate and side plates and is formed in a U-shape with an open bottom; a driver unit that is attached to a front end of the handle and includes a driver plate fixed to a front portion of a driver holder; and a magazine that is provided below the handle and stores staples therein. A rear portion of the handle and a rear portion of the magazine are concentrically and pivotally connected. Arms, each protruding from respective sides of the driver holder, are movably inserted into respective engaging holes formed on each of the side plates of the handle. When the handle is initially pushed down, rear upper parts of the driver holder come in contact with an upper inner surface of the handle so that a leading end of the driver plate is inclined toward a front side of the magazine, and when the handle is pushed down, a foremost staple in the magazine is discharged by the driver plate and binds a bunch of papers.

According to one or more embodiments of the invention, lower surfaces of the engaging holes are inclined so that the arms of the driver holder are guided forward when the bunch of papers are completely bound and the handle returns upward.

According to one or more embodiments of the invention, after the leading end of the driver plate comes in contact with the foremost staple, a front upper part of the driver holder comes in contact with the upper inner surface of the handle so that the driver plate is aligned along a front wall of the magazine.

According to one or more embodiments of the invention, when the bunch of papers is completely bound, the leading end of the driver plate does not protrude from a lower surface of the magazine.

According to one or more embodiments of the invention, when the bunch of papers is completely bound, a part of the driver unit comes in contact with an upper surface of the magazine.

According to one or more embodiments of the invention, the part of the driver unit includes a lower surface of the driver holder, and the upper surface of the magazine includes upper edges of side walls of the magazine.

According to one or more embodiments of the invention, when the bunch of papers is completely bound, the driver holder engages the magazine.

According to one or more embodiments of the invention, engaging portions of the driver plate are engaged with dowels formed on the driver holder, and the driver plate is fixed to the driver holder by riveting.

According to one or more embodiments of the invention, the dowels are formed in pairs on respective sides of the driver holder so as to be symmetric with each other above a riveting portion of the driver holder, and the engaging portions are formed in pairs on respective sides of the driver plate so as to be symmetric with each other above the riveting portion of the driver plate.

According to one or more embodiments of the invention, the engaging portions of the driver plate are arc-shaped cutout holes.

According to one or more embodiments of the invention, the stapler further includes: a base part, a magazine guide that has a U-shaped cross section and is fixed on an upper surface of the base part in a longitudinal direction; and a clincher that is fixed to both side walls of the magazine guide so as to correspond to a discharge portion formed at a front end of the magazine. The rear portion of the magazine is rotatably supported on one end of the magazine guide, and the clincher is positioned on both side walls such that longitudinal positioning means positions the clincher with respect to the longitudinal direction of the magazine guide, and such that lateral positioning means positions the clincher with respect to a lateral direction of the magazine guide.

According to one or more embodiments of the invention, the longitudinal positioning means includes positioning parts that protrude from upper edges of the side walls, and engage with and end portion of the clincher in the longitudinal direction of the magazine guide.

According to one or more embodiments of the invention, the longitudinal positioning means includes concave portions formed on upper edges of the side walls, and a convex portion that protrudes from a lower surface of the clincher and engages with the concave portions.

According to one or more embodiments of the invention, the lateral positioning means includes protrusions that protrude from the lower surface of the clincher and engage with respective inner surfaces of the side walls.

According to one or more embodiments of the invention, the stapler further includes a base cover part that covers the base part, wherein openings, through which upper edges of the side walls of the magazine guide are exposed, are formed on the base cover part.

According to one or more embodiments of the invention, when the handle is pushed down, the rear upper parts of the driver holder come in contact with the front upper inner surface of the handle. Accordingly, since the driver holder rotates and the force for moving forward the leading end of the driver plate is applied to the leading end, the leading end comes in contact with the front wall of the magazine. For this reason, the leading end reliably comes in contact with the crown of the foremost staple. As a result, since the only foremost staple is discharged, it is possible to reliably prevent two staples from being simultaneously discharged.

According to one or more embodiments of the invention, the lower front surfaces of the engaging holes, which are engaged with the arms of the driver holder, are inclined. Accordingly, when the bunch of papers is completely bound and the handle returns, the arms slide on and are guided by the lower front surfaces. For this reason, the driver plate can ascend along the front wall of the magazine. Therefore, even though the driver holder is inclined when the bunch of papers is completely bound, the attitude of the driver holder is corrected. For this reason, since the contact pressure between the driver plate and the front wall of the magazine is reduced, the driver plate is easily separated from the front wall of the magazine and the magazine is not lifted together with the driver plate. As a result, the driver plate can return smoothly.

According to one or more embodiments of the invention, after the leading end of the driver plate comes in contact with the foremost staple, the front upper part of the driver holder comes in contact with the front upper inner surface of the handle so that the driver plate corresponds with the front wall of the magazine. Accordingly, since the rear upper parts and the front upper part of the driver holder come in contact with the inner upper part of the handle, it is possible to reliably and stably discharge the foremost staple.

According to one or more embodiments of the invention, when the bunch of papers is completely bound, a leading end of the driver plate does not protrude from a lower surface of the magazine. Accordingly, when the bunch of papers is bound, a pressing distance of the staple driven by the driver plate is regulated. As a result, since the leading end does not protrude from the lower surface of the magazine and the bend of paper is reduced, it is possible to effectively suppress the swelling and wrinkles occurring at the bound portion of the paper and to make the appearance or shape of the bound portion of the bunch of papers better.

According to one or more embodiments of the invention, in the invention according to claim 1, when the bunch of papers is completely bound, a part of the driver unit comes in contact with upper surfaces of the magazine. Accordingly, it is possible to clearly confirm the driving stroke of the handle. Further, since a pressing distance of the staple driven by the driver plate is regulated, it is possible to suppress the bend of paper occurring due to the excessive driving of the staple and to effectively suppress the swelling and wrinkles occurring at the bound portion of the bunch of papers.

According to one or more embodiments of the invention, the part of the driver unit is a lower surface of the driver holder, and the upper surfaces of the magazine are upper edges of side walls of the magazine. Accordingly, the contact portion, which is used to regulate the pressing distance of the staple driven by the driver plate, can be formed by using the existing structure or slightly modifying the existing structure. As a result, it is possible to reliably obtain a contact effect without additional cost for forming the contact portion, and to reliably prevent the staple from being excessively driven by the driver plate.

According to one or more embodiments of the invention, the regulation of the lower end of the driver plate is not limited to the contact between the upper surface (upper edge) of the magazine and the part (the lower surface of the driver holder) of the driver unit.

According to one or more embodiments of the invention, the driver unit provided at the front end of the handle includes a driver holder and a driver plate attached to the driver holder. Further, engaging portions of the driver plate are engaged with dowels formed on the driver holder, and the driver plate is attached to the driver holder by riveting. Accordingly, a rotation force, that is, a reaction force of the driver plate that causes the driver plate to rotate about the riveted portion in a left and right direction in front view of the driver plate is not directly applied to the riveted portion due to the engagement between the dowels of the driver holder and the engaging portions of the river plate. For this reason, since the riveted portion is not loosened, it is possible to prevent the driver plate and the driver holder from being inclined.

Since the driving of the staple is not performed by the inclined driver plate, the reaction force applied to the leading end becomes uniform. Accordingly, the inclination of the driver holder is suppressed and the driver plate appropriately drives the staple, thereby reliably binding the bunch of papers. As a result, it is possible to obtain the bound portion of the bunch of papers, into which the staple is driven, having an excellent appearance and shape. In addition, it is possible to prevent the return failure of the driver plate, which is generated due to the inclination of the driver plate during the driving of the staple, and to prevent the driver plate and the driver holder from being damaged.

According to one or more embodiments of the invention, the dowels are formed in pairs on the driver holder so as to be symmetric with each other above the riveted portion, and the engaging portions are formed in pairs on the driver plate so as to be symmetric with each other above the riveted portion. Accordingly, in addition to the effect obtained from the stapler according to claim 1, since the rotation force is more reliably prevented due to the engagement between the pair of dowels and the engaging portions, it is possible to reliably prevent the driver plate and the driver holder from being inclined. Further, since the driver plate is balanced against any rotation force in the left and right directions, the reaction force applied to the leading end of the driver plate becomes uniform. Furthermore, the driver plate is positioned on the driver holder by using the pair of dowels and the engaging portions. As a result, when being riveted to each other, the driver plate and the driver holder do not need to be adjusted to be parallel to each other by a jig.

According to one or more embodiments of the invention, the engaging portions of the driver plate are arc-shaped cutout holes. It is possible to easily attach the driver plate to the driver holder.

According to one or more embodiments of the invention, the clincher is positioned on both side walls of the magazine by using the longitudinal positioning means and the lateral positioning means. Accordingly, since the clincher is positioned by both positioning means, it is possible to easily and reliably position the clincher and to fix the clincher not by riveting but by a screw.

According to one or more embodiments of the invention, the longitudinal positioning means includes the positioning parts that protrude from upper edges of the side walls and are engaged with the end of the clincher in the longitudinal direction of the magazine guide. Accordingly, when the clincher moves on the magazine guide in the longitudinal direction, the end of the clincher is engaged with the positioning parts and positioned in the longitudinal direction. As a result, even though a jig is not provided, it is possible to easily and reliably position the clincher by feel.

According to one or more embodiments of the invention, the longitudinal positioning means includes the concave portions formed on upper edges of the side walls and a convex portion that protrudes from a lower surface of the clincher and is engaged with the concave portions. Accordingly, the clincher is positioned in the longitudinal direction at a position where the convex portion is engaged with the concave portion. Therefore, even though a jig is not provided, it is possible to easily and reliably position the clincher by feel.

According to one or more embodiments of the invention, it is possible to fix the clincher on the side walls. Further, since the clincher is positioned by the positioning means, it is possible to perceive that the clincher is fixed at a correct position, by feel. As a result, it is possible to fix the clincher on the base cover at a correct position.

According to one or more embodiments of the invention, since the base part is covered with the base cover part, it is possible to make the entire appearance of the stapler better and to obtain an additional effect in which, for example, the positioning member for reliably positioning the bunch of papers is mounted on the base cover part. In addition, since openings through which the upper edges of the side walls of clincher attaching parts of the magazine guide are exposed are formed in the base cover part so as to correspond to the clincher, it is possible to mount the clincher on the base cover.

### BRIEF DESCRIPTION OF THE DRAWINGS

FIG. 1 is a perspective view of a stapler according to a first embodiment of the invention as seen from the front side thereof.

FIG. 2 is a perspective view of the stapler according to the first embodiment of the invention as seen from the rear side thereof.

FIG. 3 is a side cross-sectional view of the stapler according to the first embodiment of the invention.

FIG. 4 is a view illustrating one mode of the stapler being used, showing an operation of a power multiplying mechanism when a handle is pushed down.

FIG. 5 is a view illustrating another mode of the stapler being used, showing a clinch state of the stapler.

FIG. 6 is a view illustrating a handle open state of the stapler.

FIGS. 7A and 7B are views showing a driver unit of the stapler, wherein FIG. 7A is a front view and FIG. 7B is a side view.

FIGS. 8A and 8B are views showing a driver holder of the stapler, wherein FIG. 8A is a front view and FIG. 8B is a cross-sectional view taken long line X-X of FIG. 8A.

FIGS. 9A and 9B are views showing a driver plate of the stapler, wherein FIG. 9A is a front view, and FIG. 9B is a cross-sectional view taken long line Y-Y of FIG. 9A.

FIG. 10 is a perspective view of one of the main parts of the stapler according to the first embodiment of the invention.

FIG. 11 is a view illustrating an operation state of one of the main parts of the stapler according to the first embodiment of the invention.

FIG. 12 is a view showing another structure corresponding to FIG. 7.

FIG. 13 is a view showing still another structure corresponding to FIG. 7.

FIG. 14 is a perspective view of a stapler according to a second embodiment of the invention.

FIG. 15 is a side cross-sectional view showing the stapler according to the second embodiment of the invention.

FIGS. 16A to 16E are views illustrating an operation of the stapler when a staple is driven.

FIGS. 17A and 17B are enlarged views of FIGS. 16A and 16B.

FIGS. 18A to 18E are views illustrating return process of a handle after the driving of the staple is completed.

FIG. 19 is an enlarged view of FIG. 16C.

FIG. 20 is a perspective view of one of the main parts of the stapler according to the second embodiment of the invention.

FIG. 21 is a perspective view of a stapler according to a third embodiment of the invention.

FIG. 22 is a side cross-sectional view showing the stapler according to the third embodiment of the invention.

FIG. 23 is an exploded perspective view showing the positional relationship of a clincher, a base cover part, and a magazine guide.

FIG. 24 is a plan view showing that the clincher is fixed to the magazine guide.

FIG. 25 is a cross-sectional view taken along line X1-X1 of FIG. 24.

FIG. 26 is a cross-sectional view taken along line Y1-Y1 of FIG. 24.

FIG. 27A is a plan view of another example of positioning means, and FIG. 27B is a longitudinal cross-sectional view of FIG. 27A.

FIG. 28 is a view illustrating a state of a binding portion of a bunch of papers in the related art.

### BEST MODE FOR CARRYING OUT THE INVENTION

Hereinafter, embodiments of the invention will be described with reference to drawings.

### Embodiment 1

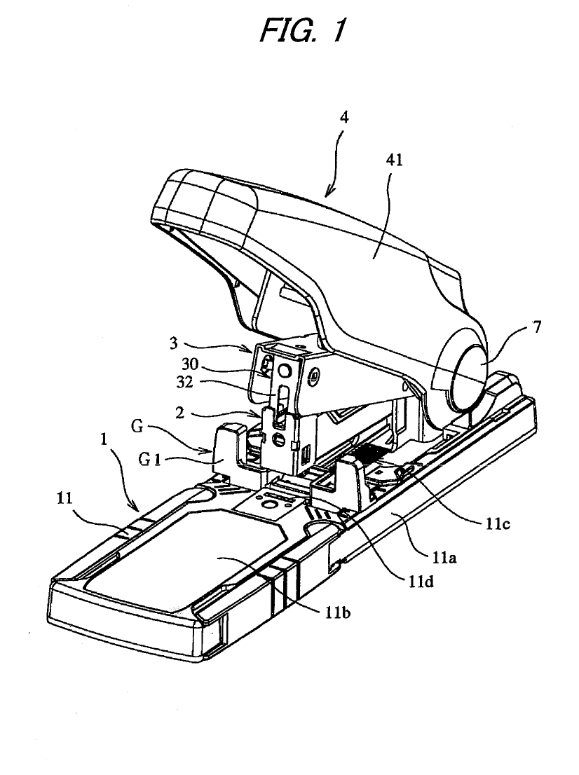

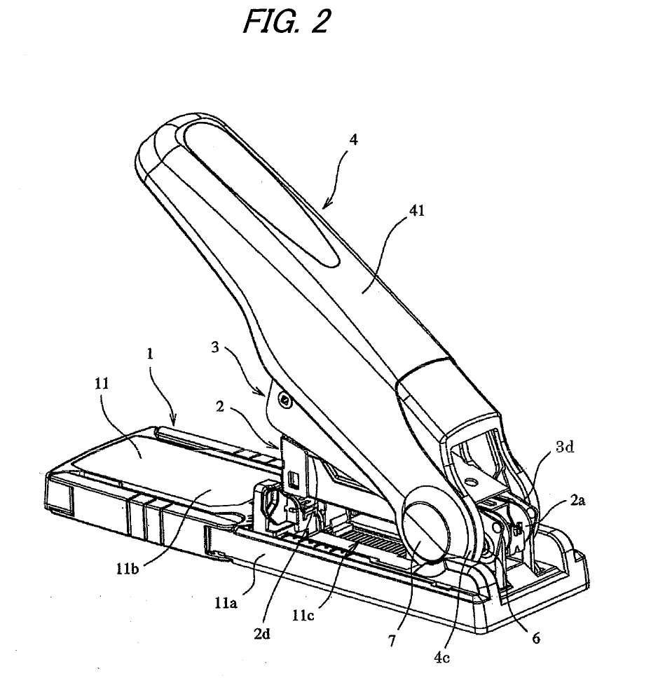

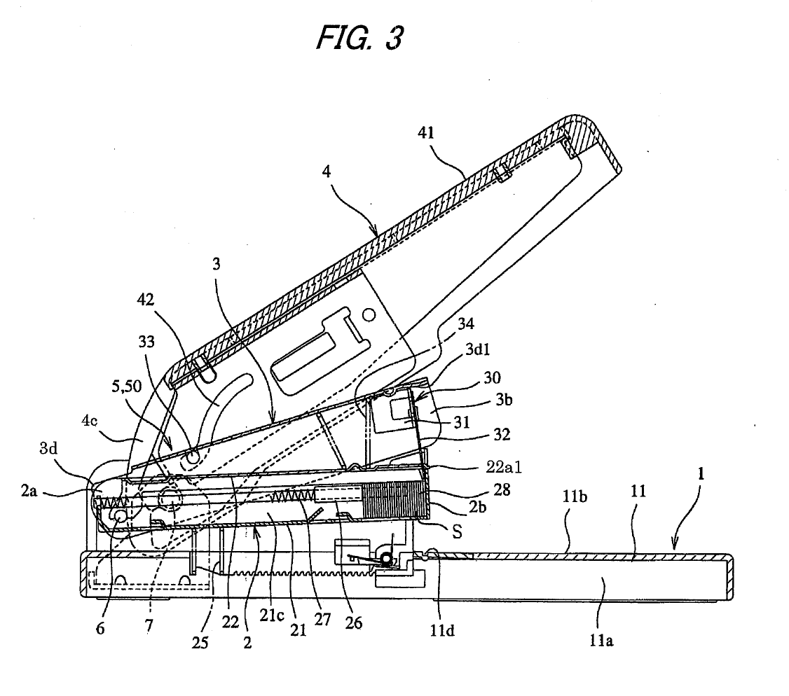

As shown in FIGS. 1 and 2, a stapler according to the first embodiment of the invention includes a base member 1, a magazine 2 in which staplers S (See FIG. 3) are stored, an inner handle 3 that includes a driver unit 30 for pressing the staplers S stored in the magazine 2 so as to bind a bunch of papers (not shown), an outer handle 4 that applies an operational force for binding the bunch of papers to the driver unit 30 through the inner handle 3, and an interlocking mechanism 5 (see FIG. 3) for interlocking the inner handle 3 and the outer handle 4 with each other. The outer surface (that is, the upper surface and the side surfaces) of the outer handle 4 is covered with a handle cover, that is, a resin cover 41.

Referring together with FIG. 3, the base member 1 is a base which rotatably supports a rear end 2a of the magazine 2 and a rear end 3d of the inner handle 3 with a same shaft by a first supporting member 6, and also rotatably supports a rear end 4c of the outer handle 4 with a second supporting member 7, at a rear side thereof. The base member 1 includes a binding table 11 of substantially a rectangular shape seen in a plane view, which is formed by bending respective sides of a sheet metal such as a steel plate that has a predetermined thickness so as to have a cross section of substantially an inverted U-shape, the binding table 11 having a pair of erected side walls 11a and a top surface 11b.

A scale groove 11c that slidably guides a positioning member G used to position the bunch of papers to be bound is provided on a top surface 11b of the base member 1. The front side (front end) of the scale groove 11c serves as a place on which the bound portion of the bunch of papers is placed, and is provided with a clinch groove 11d used to bind the bunch of papers (not shown) by pressing the staple S.

Referring to FIG. 3, the magazine 2 includes a channel-shaped member 21 and a staple cover 22. The channel-shaped member 21 is formed of a sheet metal such as a steel plate that is bent in a U-shape toward the upper side on the cross-section thereof with closed front and rear ends, and has a predetermined length. The staple cover 22 is rotated to cover the upper side of the channel-shaped member 21 and prevents the staple S stored in the channel-shaped member 21 from being separated from the channel-shaped member 21. The rear end 2a of the magazine 2 is rotatably supported by a first supporting member 6 as described above, and the magazine 2 is pushed up so as to be rotated upward by a return spring 25 that is provided between the channel-shaped member 21 and the base member 1 at a middle position slightly close to the rear end of the channel-shaped member 21.

Each of the staples S is stored in the channel portion 21c of the channel-shaped member 21, and is pushed against a discharge portion 28 to be described below by a pusher 26. The pusher 26 is provided between a pushing spring 27 and the rear portion of the staples S and comes in contact with the rear portion of the staples S, and the discharge portion 28 is formed on the front side of the channel portion 21c. The staple S is driven into the binding portion of the bunch of papers placed on the clinch groove 11d by a driver plate 32 that passes through the discharge portion 28.

The inner handle 3 is formed of a sheet metal such as a steel plate that is bent substantially in a U-shape toward the lower side on the cross-section thereof. The rear end of the inner handle 3 is rotatably supported by the first supporting member 6 provided on the rear side of the base member 1 as described above. The inner handle 3 has substantially the same length as the magazine 2, and the driver unit 30 that includes a driver plate 32 for driving a staple S during the above-mentioned paper binding process is attached to the front end of the inner handle 3.

In addition, the inner handle 3 is pushed up due to a return spring 34 that is provided between an inner surface of a front end 3b of the inner handle 3 and an upper surface of a front end 2b of the magazine 2. Accordingly, when the bunch of papers is completely bound and the operational force for driving the staple S is removed, the inner handle 3 rotates upward about the first supporting member 6, that is, in the counterclockwise direction.

As shown in FIG. 3, the inner handle 3 includes driving shaft 33 formed on the side plates at portions, which is slightly apart from the first supporting member 6 serving as a fulcrum of the inner handle 3 toward the front side. The driving shaft 33 is engaged with grooves 42 (to be described below) of the outer handle 4 and form an interlocking mechanism 5 for interlocking the inner handle 3 and the outer handle 4 with each other.

As shown in FIG. 3 and the like, a rear end 4c of the outer handle 4 is rotatably supported by a second supporting member 7 provided on the rear side of the base member 1. The outer handle 4 is formed of a sheet metal such as a steel plate that is bent substantially in a U-shape toward the lower side on the cross-section thereof. The entire outer surface of the outer handle 4 is covered with the resin cover 41. The outer handle 4 is substantially twice as long as the inner handle 3 or the magazine 2. Accordingly, the outer handle 4 is useful to increase the operational force for driving the staple S.

The above-mentioned guide grooves 42 are formed on the rear side of the outer handle 4, and the driving shaft 33 of the inner handle 3 is inserted into the grooves 42 so that the driving shaft 33 is engaged with the guide grooves 42, thereby forming the interlocking mechanism 5 for interlocking the above-mentioned inner handle 3 and outer handle 4 with each other. The interlocking mechanism 5 forms a power multiplying mechanism 50 that increases the operational force between the inner handle 3 and the outer handle 4.

In addition, when the bunch of papers is completely bound and the operational force for driving the staple S is removed, the interlocking mechanism 5 applies a return force of the inner handle 3, which is caused by the return spring 34, to the outer handle 4. Accordingly, the inner handle 3, the outer handle 4, and the magazine 2 return to an initial standby state in which the operational force for driving the staple S is not applied to them as shown in FIG. 3.

The stapler according to the first embodiment of the invention has been roughly described above. Hereinafter, the driver unit 30 of the stapler according to the first embodiment of the invention will be described in detail.

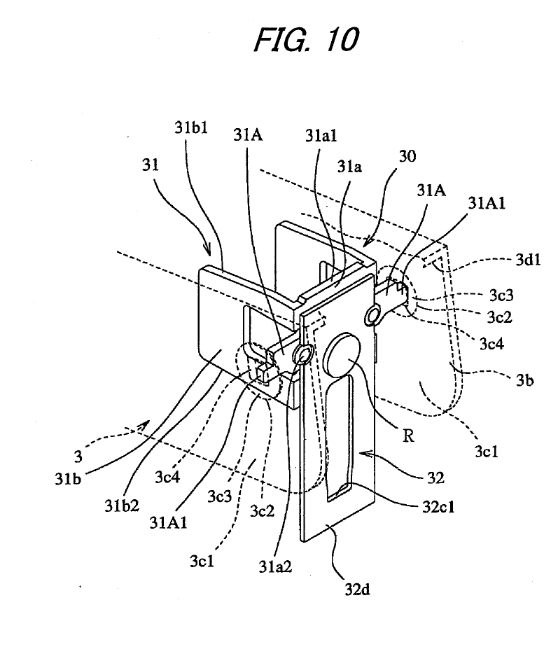

Referring to FIGS. 3 and 10, for example, the driver unit 30 is attached to the front end 3b of the inner handle 3 as described above, and includes a driver holder 31 and a driver plate 32.

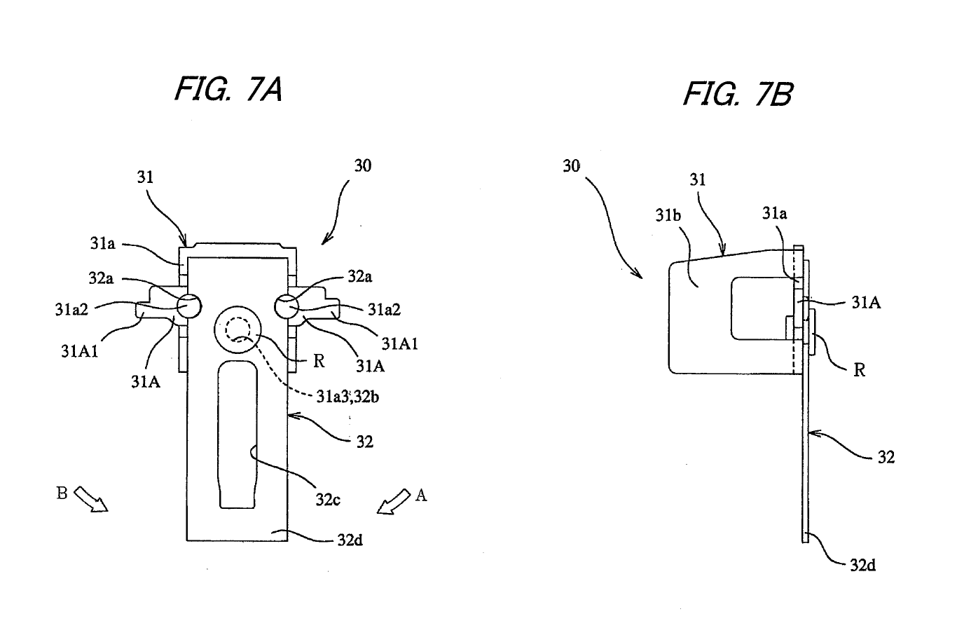

As shown in FIGS. 7A to 8B, and 10, the driver holder 31 includes side plates 31b formed in a laterally trapezoidal shape, and a front plate 31a connecting the right ends of the side plates 31b so as to form a substantially U-shape in plan view. The driver holder 31 is formed by bending a sheet metal such as a steel plate that has a predetermined thickness. Each of the upper edges 31b1 of the side plates 31b formed in a laterally trapezoidal shape in side view includes a linear part that is perpendicular to the front plate 31a, and a taper part that extends from the linear part toward the rear side. Further, each of the lower surfaces 31b2 of the side plates 31b includes a linear part that is perpendicular to the front plate 31a.

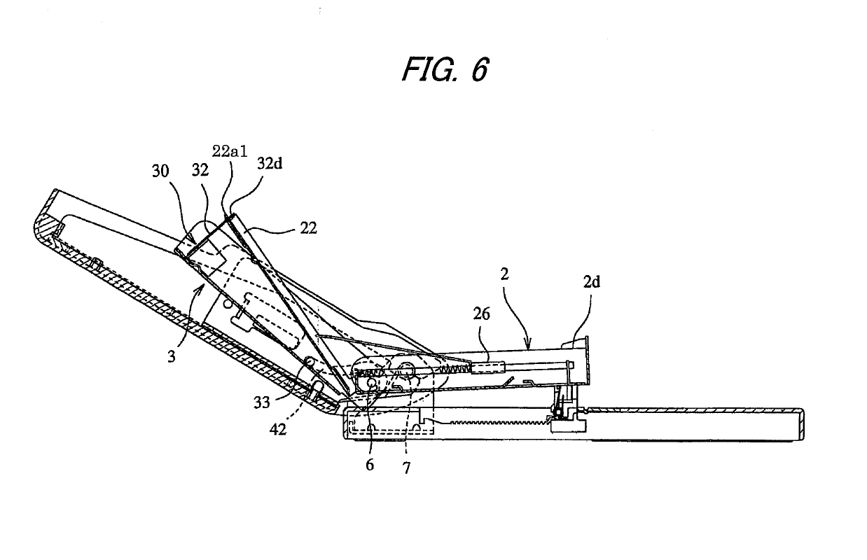

Each of the surfaces, which are formed by the linear parts of the upper edges 31b1 and the taper parts extending from the linear parts, has a predetermined shape so as to come in contact with an upper inner wall 3d1 of the front end 3b of the inner handle 3. Further, each of the surfaces, which are formed by the linear parts of the lower surfaces 31b2 perpendicular to the front plate 31a, has a predetermined shape so as to come in contact with an upper edge 2d (see FIGS. 2 and 6) of each side wall of the magazine 2.

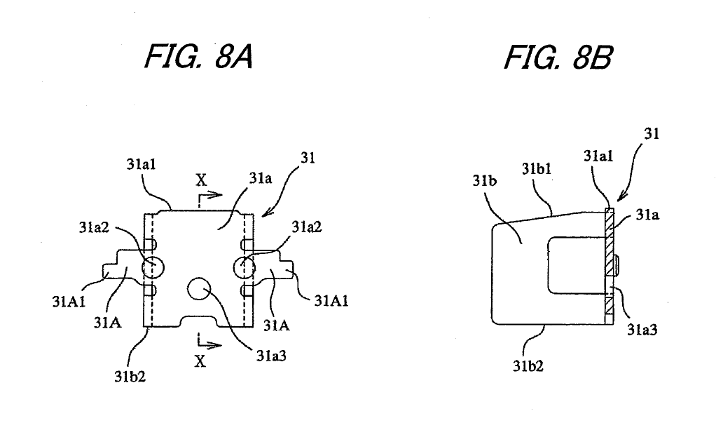

As shown in FIG. 8A, the front plate 31a for connecting the right ends of the side plates 31b is formed in a substantially rectangular shape in front view, and the upper surface 31a1 of the front plate 31a is slightly higher than the upper edges 31b1 of the side plates 31b. Further, a pair of arms 31A having a predetermined length protrudes from both sides of the front plate 31a and is positioned substantially in the middle of the front plate 31a in the vertical direction.

The pair of arms 31A includes leading ends 31A1, which each have a rectangular cross section and is cut thin so as to form steps extending toward the ends of the arms 31A, at the ends thereof. The pair of arms 31A supports the driver unit 30 between open side walls 3c1 of the front end 3b of the inner handle 3 by a supporting structure (to be described below) using the leading ends 31A1 (see FIG. 10).

Each dowel 31a2, which is press-formed and has a small protrusion height, is provided at the bases of the pair of arms 31A. In addition, one riveting hole 31a3 is formed in the front plate 31a at a position slightly below the substantially central portion thereof. The driver plate 32 is attached to the driver holder 31 by the dowels 31a2 having a small protrusion height and the riveting hole 31a3.

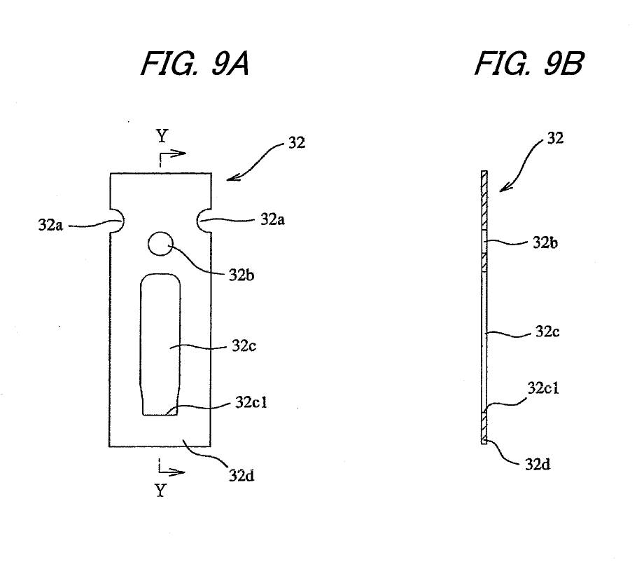

As shown in FIGS. 9A and 9B, the driver plate 32 is a plate-shaped member that is formed in a substantially rectangular shape in plan view and formed of a sheet metal such as a relatively thin steel plate. Two arc-shaped cutout holes 32a are formed on both sides of the driver plate 32 so as to be symmetric with each other. When the driver plate 32 is attached to the driver holder 31, the arc-shaped cutout holes 32a are used to position and hold the driver plate 32. Further, a riveting hole 32b, which is used to attach the driver plate 32 to the driver holder 31, is formed on the driver plate 32 at a portion that is positioned at a central portion between the two arc-shaped cutout holes 32a and slightly below the arc-shaped cutout holes 32a.

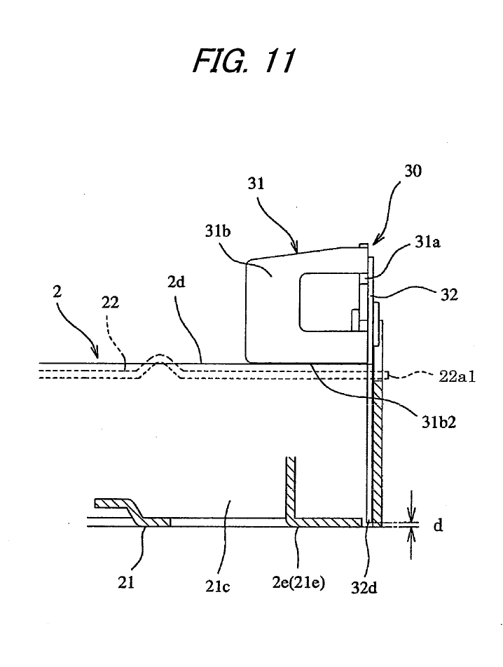

A substantially rectangular elongated hole 32c, which is substantially half as long as the driver plate 32 and is elongated in a vertical direction, is formed on the driver plate 32 below the riveting hole 32b that is used to attach the driver plate 32 to the driver holder 31. The lower edge 32c1 of the elongated hole 32c can be engaged with the front end 22a1 (see FIGS. 3 and 11) of the staple cover 22 of the magazine 2. Further, when the driver plate 32 moves upwardly, the lower edge 32c1 and the front end 22a1 are engaged with each other. Accordingly, when the driver plate 32 moves upward, the elongated hole 32c interlocks the staple cover 22 and the driver plate 32 with each other (see FIG. 6). The leading end 32d of the driver plate 32 is used to drive the staple S.

As shown in FIGS. 7A, 7B and 10, the driver plate 32 to be attached to the driver holder 31 comes in contact with the front plate 31a of the driver holder 31 from the front side, and the arc-shaped cutout holes 32a formed on both sides of the driver plate 32 are fitted to dowels 31a2, which are provided so as to correspond to the bases of the pair of arms 31A formed on both sides of the front plate 31a and have a small protrusion height. Then, a riveting pin such as a rivet R is inserted into the riveting hole 32b that is formed at the upper central portion of the driver plate 32, and a riveting hole 31a3 that is formed on the front plate 31a of the driver holder 31. After that, the riveting pin is integrally riveted to the driver plate 32 and the driver holder 31. Accordingly, the driver plate 32 is integrally attached and fixed to the driver holder 31. As a result, the driver unit 30 is formed.

In the driver unit 30, which is formed by integrally riveting the driver holder 31 and the driver plate 32, the driver plate 32 includes an elongated part extending downward from the lower surface of the driver holder 31, and the end of the elongated part is the leading end 32d that has been described above.

When the driver holder 31 and the driver plate 32 of the driver unit 30 are attached to each other as described above, it prevents the rotation force of the driver plate 32 from being generated due to a contact reaction force applied to the leading end 32d of the driver plate 32, in particular, an uneven reaction force applied to the leading end 32d, during the driving of the staple S. The rotation force of the driver plate 32 causes the driver plate 32 to rotate about the riveted portion in a left or right direction in front view of the driver plate, that is, in A and B directions in FIG. 7A. More specifically, the driver plate 32 is prevented from being rotated about the riveted portion due to the pair of arc-shaped cutout holes 32a of the driver plate 32 being engaged with the pair of dowels 31a2 of the driver holder 31.

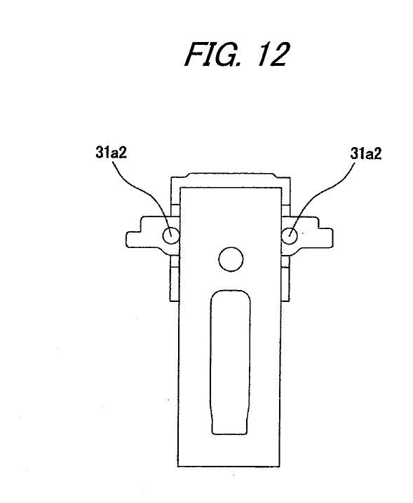

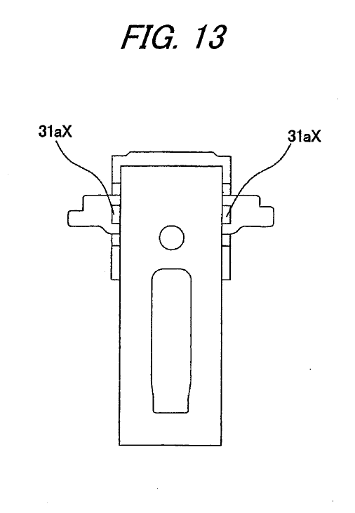

Instead of the engagement between the dowels 31a2 and the arc-shaped cutout holes 32a, as shown in FIGS. 12 and 13, both edges of the driver plate 32 may be engaged with and attached to the dowels 31a2 formed on both sides of the front plate 31a of the driver holder 31, or protruding walls 31aX press-formed on both sides of the front plate 31a.

As described above, the driver unit 30 in which the driver holder 31 and the driver plate 32 are integrally formed with each other is attached to the front end 3b of the inner handle 3 as shown in FIG. 10. That is, the driver unit 30 is attached between open side walls 3c1, which are formed in a U-shape toward the lower side on the cross-section, of the front end 3b of the inner handle 3 so as to be provided to the right side in FIG. 10, that is, at the front end of the inner handle 3.

The driver unit 30 is attached between open side walls 3c1 by disk-shaped supporting members 3c3 that are fitted to the circular holes 3c2 formed on the side walls 3c1. More specifically, the leading ends 31A1, which are formed at the ends of the arms 31A protruding from the both sides of the front plate 31a of the driver holder 31 and are cut to have a rectangular cross section, are movably inserted into rectangular holes 3c4 formed in the disk-shaped supporting members 3c3.

The driver unit 30, which is movably fitted between the open side walls 3c1 of the front end 3b of the inner handle 3, can rotate. When the driver unit 30 moves upward, the lower edge 32c1 of the elongated hole 32c formed on the driver plate 32 of the driver unit 30 is engaged with the front end 22a1 of the staple cover 22 of the magazine 2. For this reason, the rotational movement of the driver unit 30 is limited.

In addition, the upper surface 31a1 of the front plate 31a of the driver holder 31 or the upper edges 31b1 of the side plates 31b of the driver holder 31 come in contact with the upper inner wall 3d1 (see FIGS. 3 and 10) between the open side walls. For this reason, the rotational movement of the driver unit 30 caused by a strong rotational reaction force generated when the staple S is driven is regulated. As a result, it is possible to ensure a strong force for driving the staple S.

Since the rotational movement of the driver unit 30 is within a predetermined range, it is useful to ensure that the circular arc movement of the driver plate 32 is smoothly performed in the discharge portion 28 of the magazine 2 when the staple S is driven.

The driver plate 32 of the driver unit 30 is elongated in a vertical direction, and includes the leading end 32d that extends downward from the lower surface of the driver holder 31, that is, the lower surfaces 31b2 of the side plates 31b of the driver holder 31 so as to have a predetermined length. As described above, when the leading end 32d moves upward, the lower edge 32c1 of the elongated hole 32c formed on the driver plate 32 is engaged with the front end 22a1 of the staple cover 22 of the magazine 2. Accordingly, the leading end 32d is partially inserted into the discharge portion 28 in a standby state (see FIG. 3) in which the stapler is not used.

As shown in FIG. 11, when the driver plate 32 is pushed down as much as possible in the paper binding process, that is, when the staple S is driven into the bunch of papers by the leading end 32d and the bunch of papers is completely bound, the flat lower surfaces 31b2 of the side plates 31b perpendicular to the front plate 31a of the driver holder 31 come in contact with the upper edges 2d of the side walls of the magazine 2.

In this state, the length of the leading end 32d of the driver plate 32 is set so that the leading end 32d does not protrude downward from the lower surface 2e of the magazine 2, that is, the lower surface 21e of the channel-shaped member 21. Specifically, the leading end 32d is positioned to be substantially flush with the lower surface 21e. Preferably, the leading end 32d may be positioned slightly above the lower surface 21e. For example, the leading end 32d may be preferably positioned above the lower surface 21e by a thickness of the staple.

According to the specific example shown in FIG. 11, when the bunch of papers is completely bound, the length of the leading end 32d of the driver plate 32 is set so that the leading end 32d stops at a position above the lower surface 2e of the magazine 2 by an infinitesimal distance d, that is, about 0.2 mm.

In addition, the above-mentioned infinitesimal distance d is changed depending on the material of the staple S. For example, a value of 0.2 mm is set in consideration of the thickness (0.5 mm) of the staple and the accuracy of various components to be assembled, and the infinitesimal distance d may be set to 0.5 mm corresponding to the thickness of the staple.

Since the stapler according to the first embodiment of the invention has the above-mentioned configuration, the paper binding process is performed in the following procedures and operation.

First, the bunch of papers (not shown) to be bound are placed on the top surface 11b of the base member 1, and the end of the bunch of papers come in contact with a paper contact surface G1 (see FIG. 1) of the positioning member G, so that the end of the bunch of papers are positioned by the positioning member G and are held. Then, an operational force is applied to the operation portion of the outer handle 4 in the standby state shown in FIG. 3 so as to push down the outer handle 4.

When the outer handle 4 is pushed down, the outer handle 4 rotates about the second supporting member 7 serving as a fulcrum at the rear end 4c thereof. The force for pushing down the outer handle 4 is transmitted to the inner handle 3 by the driving shaft 33, which is engaged with the guide grooves 42 of the rear end 4c of the outer handle 4, of the rear end 3d of the inner handle 3.

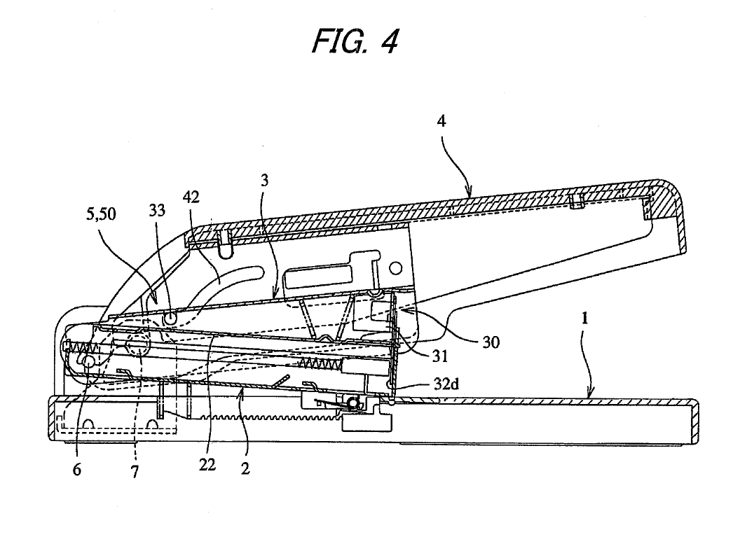

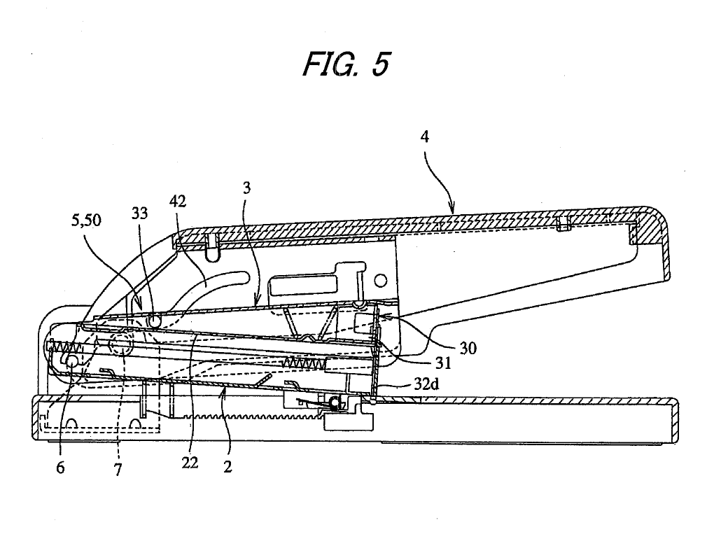

When the force for pushing down the outer handle 4 is transmitted to the inner handle 3, the inner handle 3 rotates about the first supporting member 6 serving as a fulcrum at the rear end 3d of the inner handle 3. Further, the operation of the inner handle 3 and the outer handle 4 forms a power multiplying mechanism 50 through the interlock of the inner handle 3 and the outer handle (see FIG. 4). Accordingly, the driver plate 32 of the driver unit 30, which is provided at the front end 3b of the inner handle 3, is operated by a large pressing force, so that the staple S in the discharge portion 28 is discharged to be driven into the binding portion of the bunch of papers (see FIG. 5).

The movement of the driver plate 32 for driving the staple according to the downward rotation of the inner handle 3 is continued until the lower surface of the driver unit 30 comes in contact with the upper edges 2d (see FIGS. 2, 6, and 11) of the side walls of the magazine 2, more specifically, until the flat lower surfaces 31b2 of the side plates 31b perpendicular to the front plate 31a of the driver holder 31 come in contact with the upper surface of the front end 22a1 of the staple cover 22. In this case, the driver plate 32 pushes down the upper portion of the staple S by a pressing force thereof, so that the staple is driven into the binding portion of the bunch of papers.

When the lower surface of the driver unit 30 comes in contact with the upper edges 2d of the side walls of the magazine 2, the bunch of papers is completely bound by the staple S (see FIG. 5). At this time, that is, the bunch of papers is completely bound, the leading end 32d of the driver plate 32 stops at a position slightly above the lower surface 2e of the magazine 2, that is, at a position above the lower surface 2e by an infinitesimal distance d (see FIG. 11). Accordingly, the leading end 32d faces the binding portion of the bunch of papers with a small gap, and does not directly press the bunch of papers.

In the operation of driving the staple S described above, the driving reaction force generated due to non-uniform contact applied to the leading end 32d of the driver plate 32 causes the driver plate 32 to rotate about the riveted portion in left and right directions in front view of the driver plate, that is, in an A and B directions in FIG. 7A. However, the rotation force is applied to the engaging structure between the dowels 31a2 of the driver holder and the arc-shaped cutout holes 32a formed on both side of the driver plate 32. Accordingly, the rotation force is not directly applied to the riveted portion. For this reason, the driver plate 32 is not inclined due to the looseness of the riveted portion, and the inclination of the driver holder 31 is suppressed. Since the driver plate 32 is not inclined, the staple S is smoothly driven.

When the bunch of papers is completely bound and the operational force applied to the outer handle 4 is removed, the magazine 2 and the inner handle 3 immediately rotate due to elastic forces of the return springs 25 and 34 in the counterclockwise direction, that is, upward about the first supporting member 6 serving as a fulcrum at the rear end 3d of the inner handle 3.

When the inner handle 3 rotates upward about the first supporting member 6 serving as a fulcrum at the rear end 3d of the inner handle 3, the outer handle 4 rotates upward about the second supporting member 7 serving as a fulcrum at the rear end 4c of the outer handle 4 by the interlocking mechanism 5 in which the driving shaft 33 of the inner handle 3 are engaged with the grooves 42 of the outer handle 4. The magazine 2, the inner handle 3, and the outer handle 4 return to an initial standby state in which the stapler S is not discharged by a series of these operations (see FIG. 3).

When the staples S provided in the magazine 2 are used up, staples S are appropriately supplied to the magazine 2. When both the inner handle 3 and the outer handle 4 are open, that is, both the inner handle 3 and the outer handle 4 rotate at a predetermined angle larger than 90°, the staples are supplied to the magazine 2. Since the inner handle 3 is interlocked with the staple cover 22, the staple cover does not need to be specially opened and it is possible to easily supply staples to the magazine 2.

Since the stapler according to the first embodiment of the invention has the above-mentioned configuration, it is possible to obtain the following effects.

When the lower surface of the driver unit 30, more specifically, the flat lower surfaces 31b2 of the side plates 31b perpendicular to the front plate 31a of the driver holder 31 come in direct contact with the upper edges 2d of the side walls of the magazine 2, the paper binding process performed by the driver unit 30 is completed. Accordingly, it is possible to easily confirm whether the bunch of papers is completely bound by the driving of the staple S.

Further, since the driving stroke of the handle is clearly defined, it is possible to suppress the swelling caused by the bend of paper occurring due to the excessive pressing of the staple. Furthermore, it is possible to effectively prevent the wrinkles W of the bound portion of the bunch of papers 100 that occasionally occurs as shown in FIG. 28 by the staple S in the related art.

In addition, the leading end 32d of the driver unit 30 does not protrude downward from the lower surface 2e of the magazine 2 at the final position corresponding to the driving stroke of the handle. Accordingly, when the staple S is driven, a pressing distance of the staple is limited. As a result, since the swelling and wrinkles occurring at the bound portion of the bunch of papers due to a strong tightening force of the staple S are suppressed, it is possible to provide the bound. portion of the bunch of papers having an excellent appearance.

As shown in FIG. 11, since the height of the upper surface of the staple cover 22 and the height of the upper edge 2d of each side wall of the magazine 2 are set to be substantially equal to each other, the lower surfaces 31b2 of the side plates 31b of the driver holder 31 may come in contact with the upper surface of the stapler cover 22. However, since the staple cover 22 and the magazine easily rattle, it is preferable that the lower surfaces 31b2 come in contact with the upper edges 2d.

Furthermore, the pair of arc-shaped cutout holes 32a formed on both sides of the driver plate 32 is engaged with the dowels 31a2 formed in the front plate 31a of the driver holder 31. When the staple S is driven, a reaction force is generated and is applied to the leading end 32d of the driver plate 32 to cause the driver plate 32 to rotate about the riveted portion in left and right directions in front view of the driver plate, that is, in A and B directions in FIG. 7A. However, the reaction force is not directly applied to the riveted portion due to the engagement between the arc-shaped cutout holes 32a and the dowels 31a2.

Accordingly, since the looseness of the riveted portion is suppressed, the driver plate 32 is not inclined. Further, it is possible to ensure a uniform driving force, which is caused by the leading end 32d of the driver plate 32, in the vertical direction. For this reason, since the reaction force applied to the leading end 32d becomes uniform, the inclination of the driver holder 31 is suppressed and the staple S is reliably driven. As a result, it is possible to provide the bound portion of the bunch of papers having an excellent appearance and shape. In addition, since the inclination of the driver plate 32 and the driver holder 31 is suppressed, it is possible to prevent the operation failure in using the magazine 2 having a small height (for example, one-touch open type magazine).

Since the pair of arc-shaped cutout holes 32a formed at the upper portion of the driver plate 32 is engaged with the pair of dowels 31a2 formed on both sides of the front plate 31a of the driver plate 31 from the front side, the attachability therebetween is excellent. In addition, since the driver plate 32 is positioned on and attached to the driver holder 31 due to the engagement therebetween, the driver plate and the driver holder can be riveted to each other without parallel position adjustment. As a result, it is possible to reduce assembly cost.

### Embodiment 2

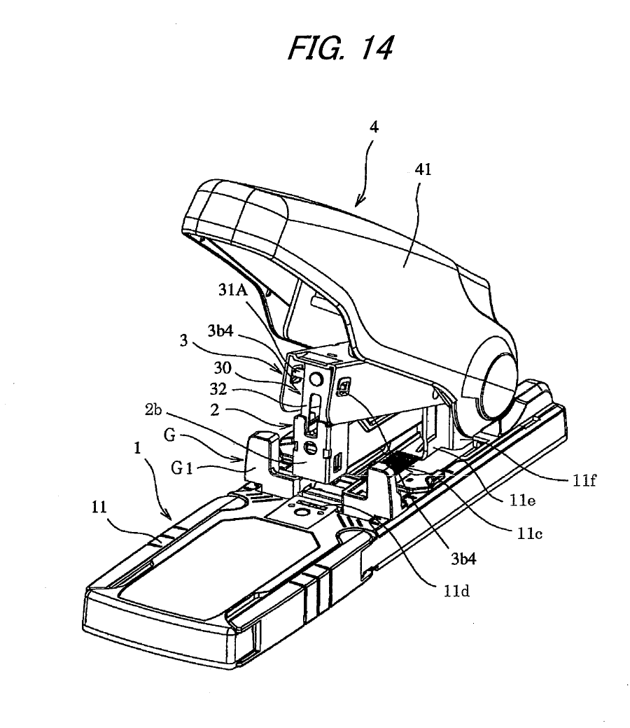

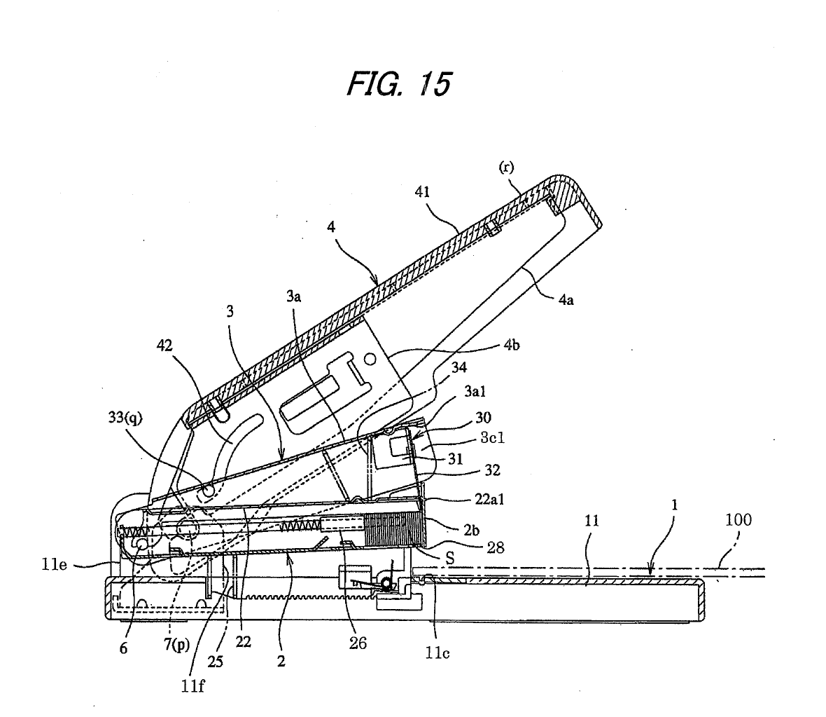

FIG. 14 is a perspective view of a stapler according to a second embodiment of the invention, and FIG. 15 is a longitudinal cross-sectional view of the stapler. In the FIGS. 14 and 15, reference numeral 1 indicates a base member. A binding table 11 on which a bunch of papers is placed is formed on the front side of the base member 1, and a magazine guide 11e and a handle supporting plate 11f stands at the rear end of the base member 1. A magazine 2 and an inner handle 3 are rotatably supported by a first supporting member 6 provided in the magazine guide 11e. In addition, an outer handle 4 for operating the inner handle 3 is rotatably supported by a second supporting member 7 provided in the handle supporting plate 11f.

The magazine 2 has a space in which connected staples S are stored, and a discharge portion 28 is formed at the front end of the magazine 2. Further, a pusher 26 for pushing the connected staples S against the discharge portion 28 is provided in the magazine 2.

A driver unit 30 is provided at the front end of the inner handle 3.

In addition, the outer handle 4 is used to operate the inner handle 3, and the outer handle 4 includes two long and short handle members 4a and 4b that are integrally connected with each other. The outside of the outer handle 4 is covered with a cover 41 made of a resin. Guide grooves 42 curved in a gentle S shape are formed on the side surfaces of the short handle member 4b, and driving shaft 33 protruding from both sides of the inner handle 3 is inserted into the guide grooves 42. Accordingly, a power multiplying mechanism is configured so that a ratio of a distance between a point (r) to which a force is applied and a pivot (p) of the outer handle 4 to a distance between a point (q) of application and the pivot (p) of the outer handle 4 is large.

When the outer handle 4 is pushed down, the driving shaft 33 inserted into the guide grooves 42, the inner handle 3, and a driver plate 32 of the driver unit 30 move downward. As a result, the foremost staple supplied to the front end of the magazine 2 is discharged through the discharge portion 28. After that, the legs of the staple penetrate the bunch of papers 100 placed on the binding table 11, and are then pressed against a clinch groove 11d formed on the binding table 11. Accordingly, the legs of the staple are bent and bind the bunch of papers 100. When a paper binding process is completed, the magazine 2, the inner handle 3, and the outer handle 4 return to initial positions shown in FIG. 14 due to a first spring 25 and a second spring 34. Further, the pusher 26 supplies the staples to the discharge portion 28 one by one, so that next paper binding process is prepared.

According to the stapler having the above-mentioned configuration, even though the force for pushing down the outer handle 4 is small, a still larger force is obtained as compared to when the driver plate 32 is directly pushed down using the inner handle 3. Therefore, it is useful to bind the bunch of papers.

The configuration of the stapler mentioned above is substantially the same with those of the stapler according to the first embodiment. Further, since a configuration of a driver unit according to the second embodiment is also substantially the same as that of the first embodiment, the explanation thereof will be omitted.

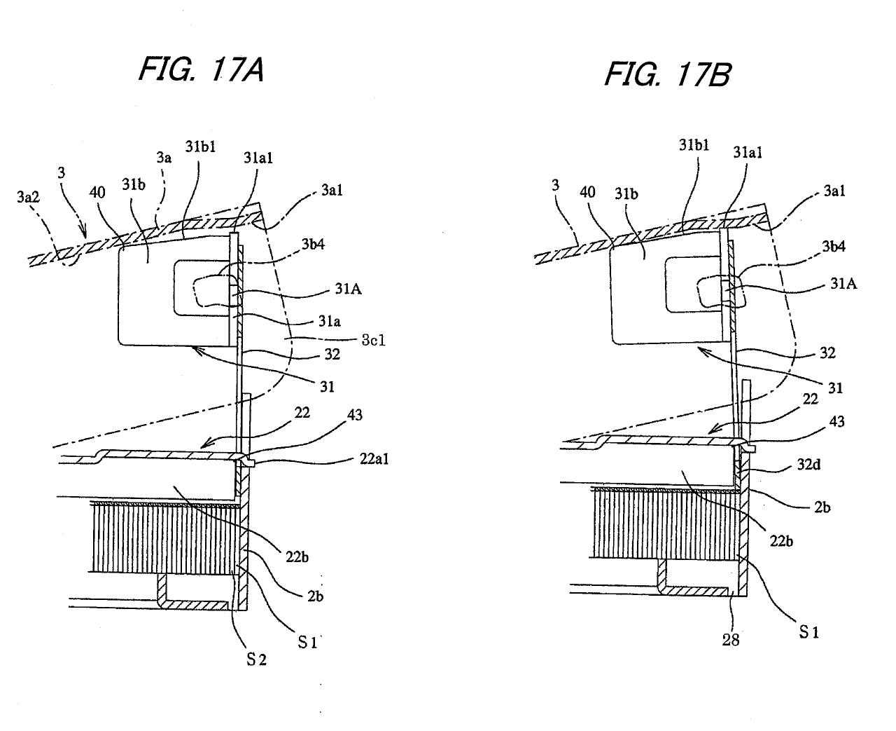

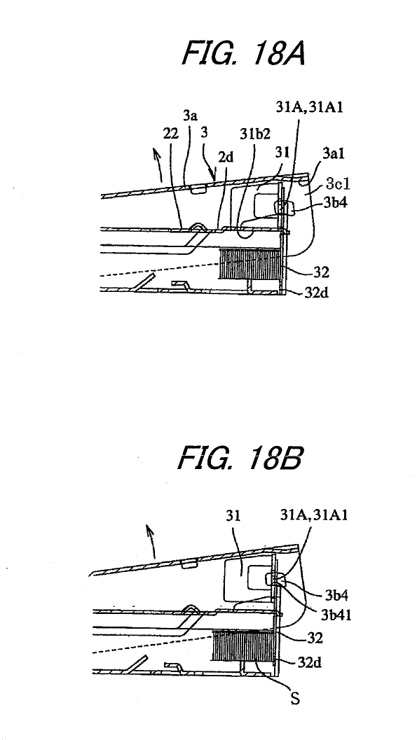

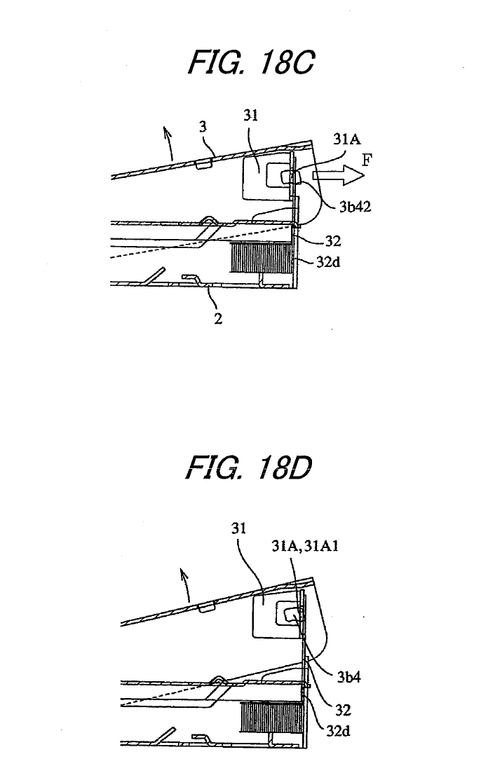

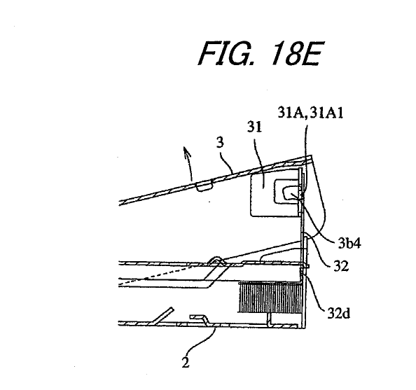

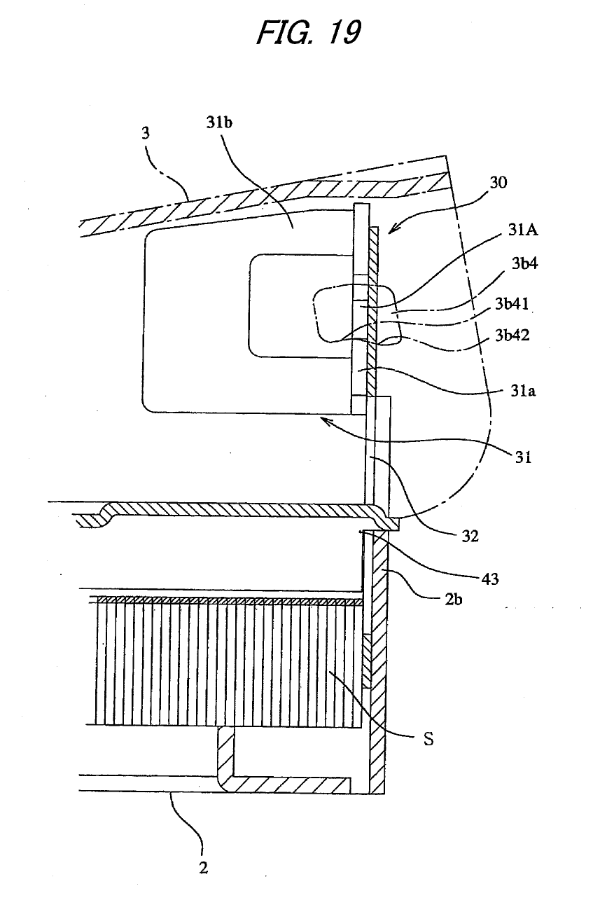

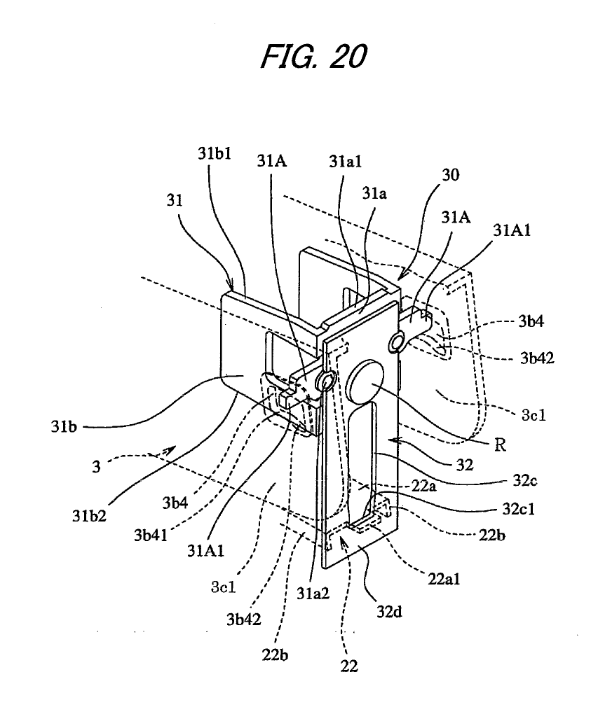

According to the second embodiment, as shown in FIG. 20, the leading ends 31A1 of the pair of arms 31A protruding from both sides of the front plate 31a are movably fitted into the engaging holes 3b4 that are formed in the front portions of the open side walls 3c1 and have a U-shape toward the lower side on the cross-section of the inner handle 3. Accordingly, the driver unit 30 is supported by the inner handle 3. Further, the front upper inner surface 3a1 (see FIG. 17A) of the inner handle 3 is curved and protrudes downward. When the staple is in the standby state (see FIG. 18E), there is a predetermined gap between the protruding portion of the front upper inner surface 3a1 and the upper portion of the driver unit 30. Therefore, the driver unit 30 freely moves in a predetermined range. In addition, as shown in FIG. 19, the lower front surfaces 3b42 of the engaging holes 3b4 are inclined forward and downward.

As shown in FIGS. 7A and 20, the width of the elongated hole 32c of the driver plate 32 is gradually decreased. When a protrusion is formed at the front end 22a1 of a staple cover 22 in a width direction, the driver plate 32 can move only between the protrusion and the front ends of the side plates 22b of the driver cover 22. The staple cover 22 is rotatably and pivotally connected to the first supporting member 6.

The staple cover 22 includes an upper plate 22a and side plates 22b, and has a U-shaped cross section. Further, the front end 22a1 of the upper plate 22a is engaged with the lower edge 32c1 of the elongated hole 32c formed on the driver plate 32. For this reason, the driver plate 32 can move forward, but cannot move behind the front ends of the side plates 22b. A second spring 34 is provided between the inner handle 3 and the staple cover 22 as described above, and an elastic force is generated therebetween so that the inner handle 3 is separated from the staple cover 22. Accordingly, the driver unit 30 assembled as described above is stretched between the inner handle 3 and the staple cover 22. As shown in FIG. 18E, the inner handle 3, the staple cover 22, and the driver unit 30, which are assembled as described above, are provided so that there is a predetermined gap between the leading end 32d of the driver plate 32 and the crowns of the connected staples S positioned at the discharge portion 28 of the magazine 2 in the standby state of the staples.

Since the stapler according to the second embodiment of the invention has the above-mentioned configuration, the paper binding process is performed in the following procedures and operation.

According to the stapler in the standby state, the lower edge 32c1 (see FIG. 20) of the elongated hole of the driver plate 32 of the driver unit 30 is engaged with the front end 22a1 of the staple cover 22, and the leading end 32d of the driver plate 32 faces inside the magazine 2 (see FIG. 14).

In the paper binding process, first, a bunch of papers (not shown) are placed on the base member 1, and the ends of the sheets of paper come in contact with a contact surface G1 (see FIG. 14) of a positioning member G that is appropriately positioned on a scale groove 11c. An operational force is applied to the operation portion of the outer handle 4 so as to push down the outer handle 4.

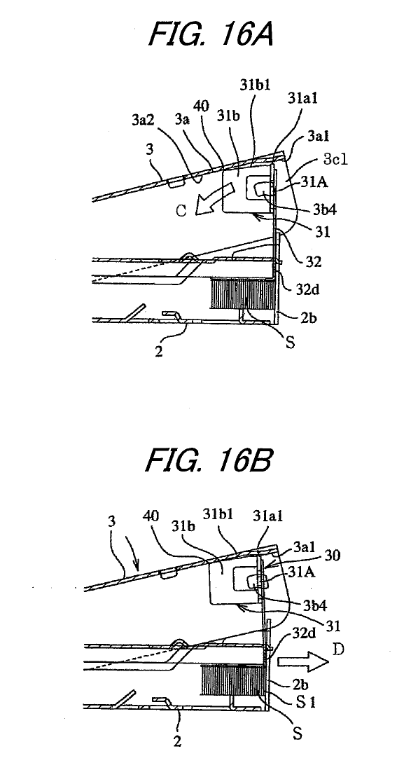

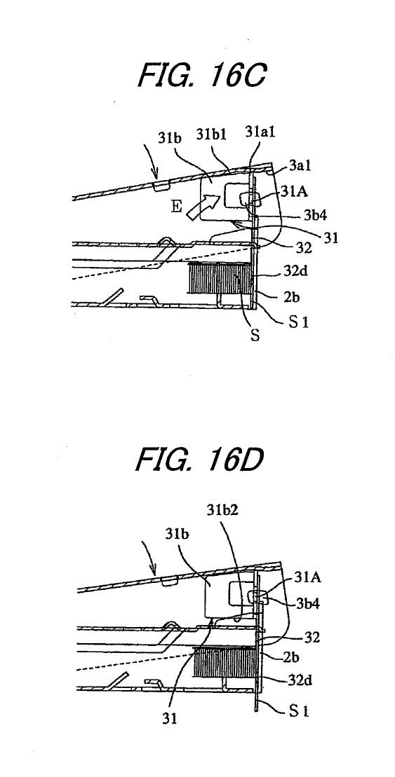

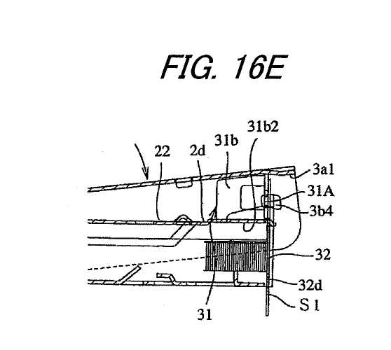

When the force for pushing down the outer handle 4 is transmitted to the inner handle 3, the inner handle 3 begins to rotate downward about the first supporting member 6. At this time, as shown in FIG. 16A, as the above-mentioned operational force resists against the elastic force of the second spring 34 (see FIG. 15), the distance between the inner handle 3 and the magazine 2 is reduced. Accordingly, the driver unit 30 also descends toward the staples S. In addition, since the distance between the inner handle 3 and the magazine 2 is reduced, the state of the driver unit 30 is changed from the state in which the driver unit 30 is stretched between the inner handle 3 and the staple cover 22 into the suspended state in which the leading ends 31A1 of arms 31A movably fitted into the engaging holes 3b4 of the inner handle 3. In this state, since the rear upper parts 40 of the side plates 31b of the driver holder 31 come in contact with the front upper inner surface 3a2 of the inner handle 3, a rotation moment is applied to the driver unit 30 in a direction indicated by an arrow C shown in FIG. 16A. As a result, the driver unit 30 rotates, so that the leading end 32d of the driver plate 32 moves forward (right side in FIG. 16A) and comes in contact with a front wall 2b of the magazine 2.

In this state, when the inner handle 3 is further pushed down, the leading end 32d of the driver unit 32 slides on the front wall 2b of the magazine 2 and descends so as to come in contact with the crown of the foremost staple S1 positioned at the discharge portion 28 of the magazine 2 as shown in FIG. 16B. At this time, since the driver unit 30 is supported at two points by the leading end 32d of the driver plate 32 and the rear upper parts 40 of the side plates 31b of the driver holder 31 in side view, the driver unit 30 is in an unstable state. However, when the inner handle 3 is still further pushed down, the front upper inner surface 3a1 of the inner handle 3 and the upper surface 31a1 of the front plate 31a of the driver holder 31 come in contact with each other. Therefore, the driver unit 30 is supported at three points, which include the front upper inner surface 3a1 and the above-mentioned two points, in side view. As a result, the driver unit 30 is in a stable state.

As described above, until the inner handle 3 rotates and the leading end 32d of the driver plate 32 comes in contact with the crown of the foremost staple S1 positioned at the discharge portion 28 of the magazine 2, the force for moving forward the leading end 32d is applied to the leading end 32d of the driver plate 32 as shown by an arrow D in FIG. 16B. As a result, the leading end 32d can reliably come in contact with the only foremost staple S1 of the connected staples S positioned at the discharge portion 28 of the magazine 2. When the inner handle 3 is still further pushed down, both the front upper inner surface 3a1 and the upper surface 31a1 of the front plate 31a of the driver holder 31 protrude forward. Accordingly, the front upper inner surface 3a1 and the upper surface 31a1 come in press contact with each other. Further, at this time, since the taper part of each upper edge 31b1 of the river holder 31 has an inclination similar to the front upper inner surface 3a2 of the inner handle 3, the rear upper parts 40 of the side plates 31b of the driver holder 31 and the front upper inner surface 3a2 of the inner handle 3 come in light contact with each other. As a result, a moment is applied to the driver unit 30 in a direction indicated by an arrow E shown in FIG. 16C, so that the front surface of the driver plate 32 and the front wall 2b of the magazine 2 come in contact with each other in a substantially entire overlapping portion therebetween and the leading end of the driver plate 32 slides along the front wall 2b of the magazine 2 in the staple driving direction. For this reason, the staple S1 is discharged perpendicular to the magazine 2 (see FIG. 16D).

The outer handle 4 for driving the staple S1 is continuously pushed down until the lower surfaces 31b2 of the driver holder 31 come in contact with the upper surface 2d of the magazine 2. During this period, one staple S1 of the connected staples S in the discharge portion 28 is discharged by the pushing force of the leading end 32d of the driver plate 32, so that the staple S1 is driven into the binding portion of the bunch of papers (see FIG. 16E).

In addition, when the inner handle moves downward, the leading end 32d of the driver plate 32 comes in contact with the crown of the foremost staple S1 and the arms 31A of the driver holder 31 then moves upward with respect to the engaging holes 3b4 of the inner handle 3. Therefore, the arms 31A are separated from the lower surfaces 3b41 of the engaging holes 3b4 of the inner handle 3. However, since the arms 31A move upward with respect to the engaging holes 3b4, the rear upper parts 40 of the side plates 31b of the driver holder 31 come in contact with the front upper inner surface 3a2 of the inner handle 3. As a result, the arms 31A are not engaged with the upper surfaces of the engaging holes 3b4. That is, while the inner handle 3 moves downward, the leading end 32d of the driver plate 32 comes in contact with the crown of the foremost staple S1 and the engaging holes 3b4 become independent of the downward movement of the driver unit 30.

In addition, even when the inner handle 3 is pushed down, the rear upper parts 40 of the side plates 31b of the driver holder 31 come in contact with the front upper inner surface 3a2 of the inner handle 3 until just before the staple is driven. For this reason, in the driver unit 30, three points, that is, the rear upper parts 40, the upper surface 31a1 of the front plate 31a, and the leading end 32d of the driver plate 32 come in contact with the front upper inner surface 3a2 of the inner handle 3, the front upper inner surface 3a1, and the upper surface of the staples S. Therefore, the driver plate 32 is stably supported. Just before the driving of the staple is completed, the rear upper parts 40 are separated from the front upper inner surface 3a2, so that the next ascending process is prepared.

Next, a return process of the inner handle after stapling will be described with reference to FIGS. 15, 18A to 18E, and 19.

First, when the paper binding process is completed and the operational force applied to the outer handle 4 is removed, the magazine 2 and the inner handle 3 rotate about the first supporting member 6 in the counterclockwise direction, that is, upward due to elastic forces of the first spring 25 and the second spring 34, and begin to return (see FIG. 18A).

When the inner handle 3 begins to move upward, the upper plate 3a of the inner handle 3 is separated from the driver holder 31. Accordingly, the driver holder 31 becomes free. Further, pressure caused by the connected staples S is applied to the driver plate 32 from the rear side, and the pressure is high until the driver plate 32 begins to move. For this reason, it is maintained in the state in which the driver plate 32 comes in contact with the front wall 2b. After that, the arms 31A of the driver holder 31 are engaged with the rear portion of the lower surfaces 3b41 of the engaging holes 3b4 of the inner handle 3, and the driver holder 31 moves to be lifted in this state as shown in FIG. 18B.

In addition, as the inner holder 3 rotates upward, the engaging holes 3b4 move rearward. However, since it is maintained in the state in which the driver plate 32 comes in contact with the front wall 2b, the arms 31A of the driver holder 31 move forward with respect to the engaging holes 3b4. When the inner handle 3 rotates upward, the arms 31A move up to the lower front surfaces 3b42 of the engaging holes 3b4. Since the lower front surfaces 3b42 are inclined forward and downward, the contact friction between the arms 31A and the lower front surfaces 3b42 is reduced. For this reason, as the inner handle 3 rotates upward, the arms 31A are guided in a direction indicated by an arrow F by the inclined lower front surfaces and naturally move forward (see FIGS. 18C and 19). Accordingly, while the inner handle 3 rotates upward, the driver plate 32 is always oriented in a direction perpendicular to the magazine 2 and ascends to the initial position along the front wall 2b of the magazine 2 (see FIGS. 18D and 18E). Therefore, even though the driver holder 31 is inclined when the paper binding process is completed, the attitude of the driver holder 31 is corrected. For this reason, since the contact pressure between the driver plate 32 and the front wall 2b of the magazine 2 is reduced, the driver plate 32 is easily separated from the front wall 2b of the magazine 2 and the magazine 2 is not lifted together with the driver plate 32 during the separation of the driver plate 32. As a result, the driver plate 32 can return smoothly.

As described above, when the inner handle 3 is pushed down during the paper binding process and the inner handle 3 rotates, the rear upper parts 40 of the side plates 31b of the driver holder 31 come in contact with the front upper inner surface 3a2 of the inner handle 3 before the leading end 32d of the driver plate 32 comes in contact with the crown of the foremost staple S1. As a result, since the driver unit 30 rotates and the force for moving forward the leading end 32d is applied to the leading end 32d of the driver plate 32, the leading end 32d comes in contact with the front wall 2b of the magazine 2. For this reason, since the leading end 32d can reliably come in contact with the crown of the foremost staple S1, it is possible to discharge the staple through the discharge portion 28 of the magazine 2.

In addition, the lower front surfaces 3b42 of the engaging holes 3b4 of the inner handle 3, which are engaged with the arms 31A of the driver holder 31, are inclined. Accordingly, when the paper binding process is completed and the inner handle 3 rotates upward, the arms 31A slide on and are guided by the lower front surfaces 3b42. For this reason, the driver plate 32 can ascend along the front wall 2b of the magazine 2. Therefore, the contact pressure between the driver plate 32 and the front wall 2b of the magazine 2 is reduced, so that sliding friction is reduced. Accordingly, the driver plate 32 is easily separated from the front wall 2b of the magazine 2 and the magazine 2 is not lifted together with the driver plate 32 during the separation of the driver plate 32. As a result, the driver plate 32 can return smoothly.

### Embodiment 3

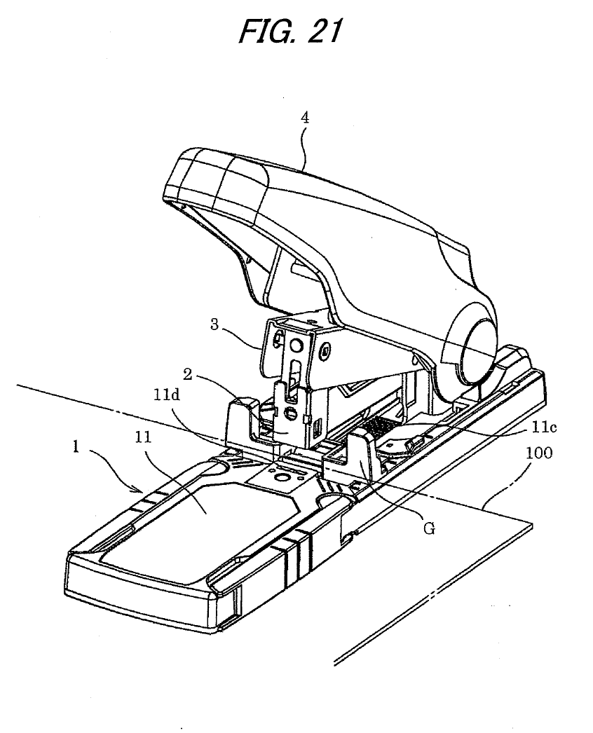

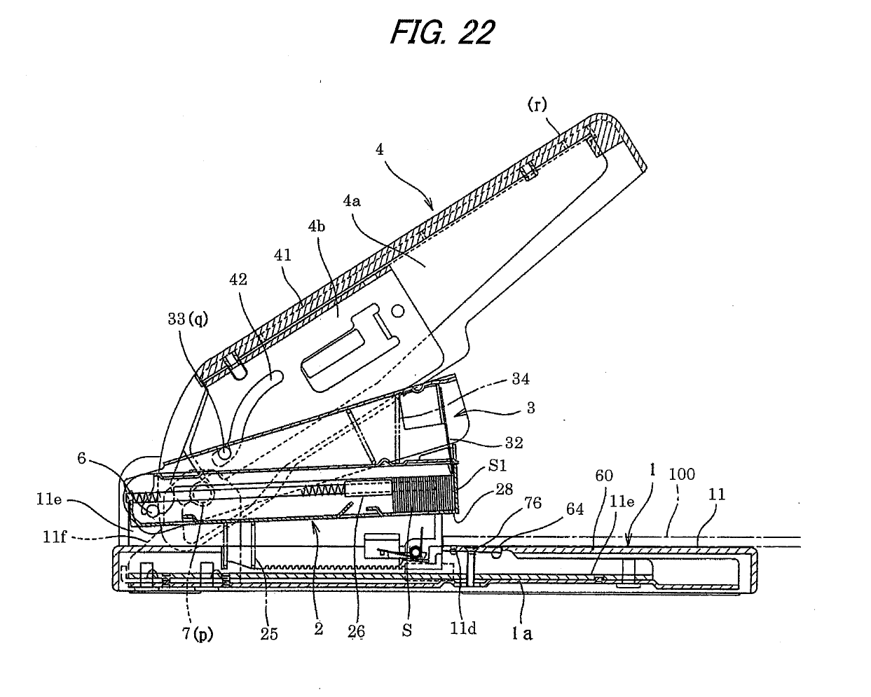

FIG. 21 is a perspective view of a stapler according to a third embodiment of the invention, and FIG. 22 is a longitudinal cross-sectional view of the stapler. Explanations of features that are substantially the same with those of the stapler according to the first and second embodiments will be omitted.

According to the third embodiment, a base part 1a, which is made of a metal, of the base member 1 is covered with a base cover part 60 made of a synthetic resin. Accordingly, the clinch groove 11d is positioned and fixed on the magazine guide 11e disposed below the base cover part 60.

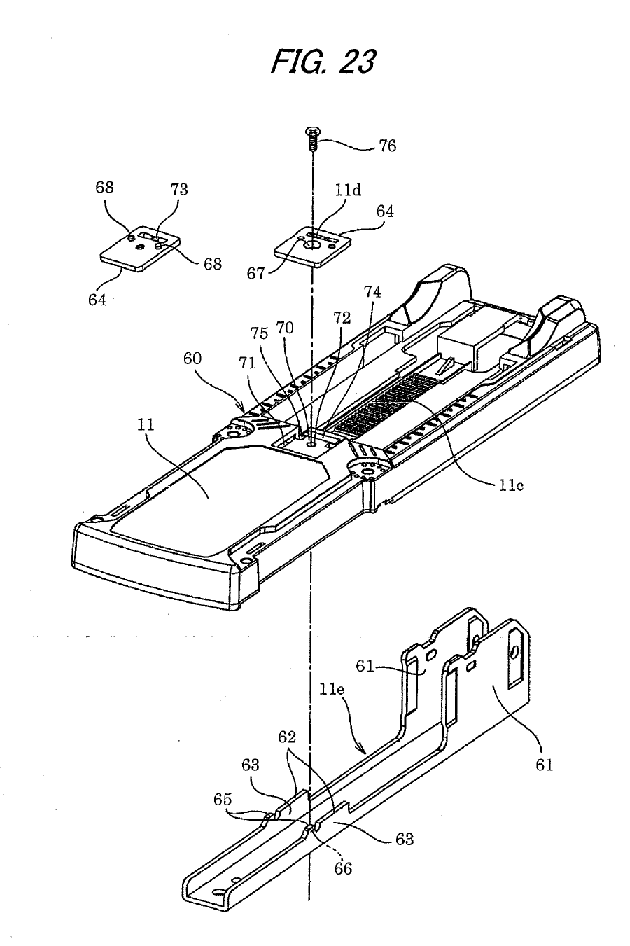

That is, as shown in FIG. 23, the magazine guide 11e is a metal member that has a U-shaped cross section and includes standing walls 61 having a large height on both sides of one end (rear end) thereof. Further, the magazine guide 11e is fixed on the upper surface of the base part 1a in the longitudinal direction. The first supporting member 6 (see FIG. 22), which supports the magazine 2 and the inner handle 3, is mounted in the standing walls 61. Clincher attaching parts 62 are formed at the other end (front end) of the magazine guide 11e so as to correspond to the discharge portion 28 of the magazine 2. Both side walls 63 of the clincher attaching parts 62 protrude from left and right side walls of the magazine guide 11e to have a predetermined height, and positioning parts 65 are formed on the front sides of the clincher attaching parts 62. The positioning parts 65 form steps on the side walls 63. The steps may be formed so that it can be felt that the front end of the clincher 64 is bumped against the steps when a clincher 64 is slid from the rear side toward the front side. In addition, a tapped hole 66 is formed at the bottom of the clincher attaching parts 62.

The clincher 64 is a metal plate formed in a substantially rectangular shape, and a screw insertion hole 67 is formed at the center of the clincher 64. The clinch groove 11d is formed at one end of the clincher 64. A pair of left and right protrusions 68 is formed on the lower surface of the clincher 64. A distance between the outer surfaces of the protrusions 68 is substantially equal to a distance between the inner surfaces of the side walls 63 of the clincher attaching parts 62 of the magazine guide 11e.

Further, a recess 70 is formed on the base cover part 60 so as to correspond to the clincher attaching parts 62. Openings 71 through which the side walls 63 of the clincher attaching parts 62 of the magazine guide 11e are exposed are formed on both sides of the recess 70. In addition, an insertion hole 72 is formed in the recess 70 so as to correspond to the screw insertion hole 67 of the clincher 64, and a groove 74 is formed in the recess 70 so as to correspond to the clinch groove 11d. The groove 74 prevents the recess 70 from being interfered with a protrusion 73 that protrudes from the surface of the clincher 64 opposite to the clinch groove 11d. Further, cutout holes 75 slightly larger than the protrusions 68 are formed in the recess 70 so as to correspond to the protrusions 68 of the clincher 64.

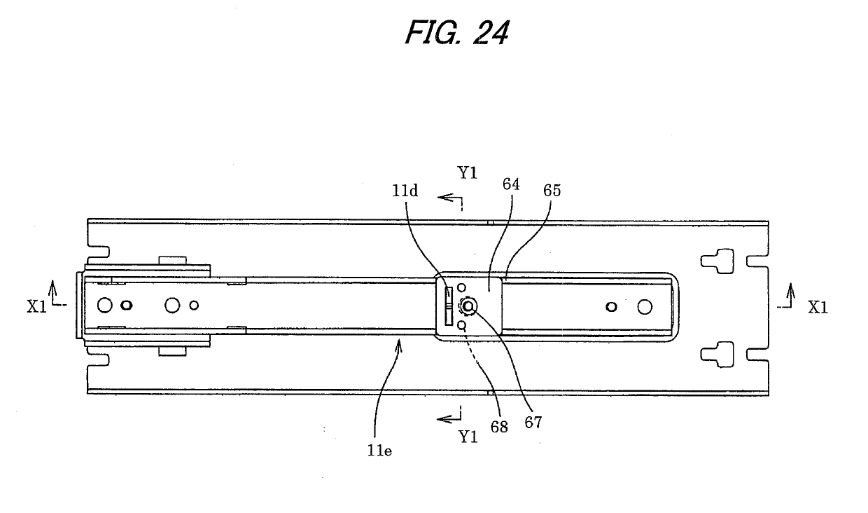

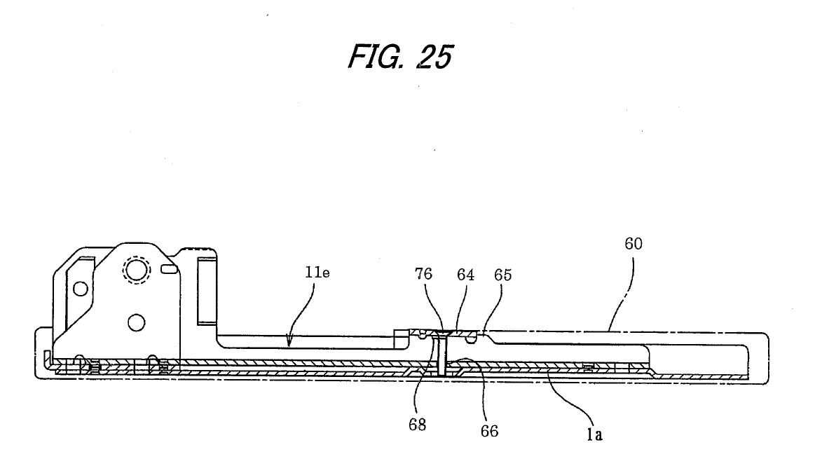

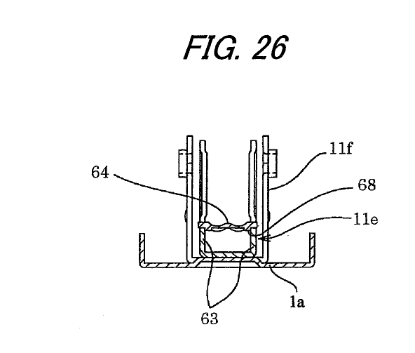

When the clincher 64 is fixed to the magazine guide 11e, the base cover part 60 is first fixed on the base part 1a. In this case, the side walls 63 of the clincher attaching parts 62 of the magazine guide 11e are exposed through the openings 71 of the recess 70. Then, the clincher 64 is inserted into the recess 70, and is slid from the rear side toward the front side so that the front end of the clincher 64 is bumped against the positioning parts 65 of the side walls 63, as shown in FIGS. 24, 25, and 6. In addition, the clincher 64 is moved from the left side toward the right side so that the protrusions 68 protruding from the cutout holes toward the backside of the base cover part 60 are engaged with the inner surfaces of the side walls 63. Accordingly, the front, rear, left, and right ends of the clincher 64 are positioned. Then, a fixing screw 76 is inserted into the screw insertion hole 67 of the clincher 64 and the insertion hole 72 of the recess 70, and may be fastened into the tapped hole 66 formed at the bottom of the magazine guide 11e.

As described above, it is possible to easily and reliably position the front, rear, left, and right ends of the clincher 64 without visually checking.

In addition, since the base cover part 60 made of resin is attached to the base part, as shown in FIG. 21, it is possible to make the entire appearance of the stapler better. Further, a deep scale groove 11c is formed on the base cover part 60 made of resin. Accordingly, when a positioning member G including engaging means engageable with the scale groove 11c is slidably mounted to the base cover part 60 and the end of a bunch of papers are positioned, it is possible to reliably stop and maintain the positioning member G at a predetermined position by engaging the engaging means with the scale groove 11c.

Although longitudinal positioning means that positions the clincher 64 in the longitudinal direction of the magazine guide 11e is formed of steps (positioning parts 65) against which the front end of the clincher 64 is bumped, the positioning means is not limited to the steps. The positioning means may position not the front end of the clincher but the rear end of the clincher.

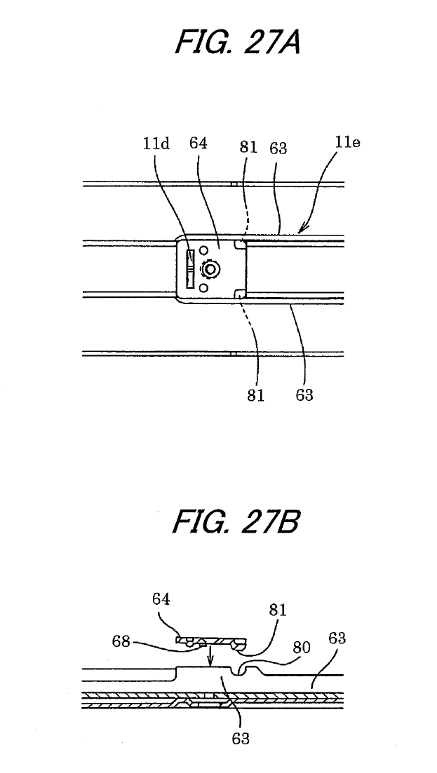

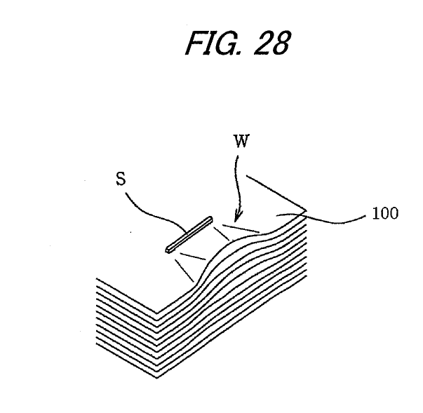

In addition, as shown in FIGS. 27A and 27B, the positioning means may be formed of a concave portion 80 that is formed on the edges of the side walls 63 of the magazine guide 11e, and a convex portion 81 that protrudes from the lower surface of the clincher 64 and is engaged with the concave portion 80. According to the above-mentioned configuration, the clincher 64 is positioned in the longitudinal direction at a position where the convex portion 81 is engaged with the concave portion 80. Therefore, even though a jig is not provided, it is possible to easily and reliably position the clincher by feel.

Further, lateral positioning means that positions the clincher 64 in the lateral direction is not limited to the pair of protrusions 68 protruding from the lower surface of the clincher 64. The protrusions may be formed of a single piece.

While there has been described in connection with the embodiments of the present invention, it will be obvious to those skilled in the art that various changes and modification may be made therein without departing from the present invention. It is aimed, therefore, to cover in the appended claim all such changes and modifications as fall within the true spirit and scope of the present invention.

The subject patent application is based on a Japanese patent application No. 2005-333983 filed on Nov. 18, 2005, Japanese patent application No. 2005-333984 filed on Nov. 18, 2005, Japanese patent application No. 2005-337791 filed on Nov. 22, 2005, Japanese patent application No. 2005-363337 filed on Dec. 16, 2005, the contents of which are incorporated herein by reference.

### INDUSTRIAL APPLICABILITY

Although a large size stapler including a power multiplying mechanism has been described in the above embodiments, it can also be applied to a common stapler, that is, a stapler in which the above-mentioned outer handle is not included, and the handle (inner handle) is directly pushed down to bind the bunch of papers.

1. A stapler comprising:
a handle that includes an upper plate and side plates and is formed in a U-shape with an open bottom;
a driver unit that is attached to a front end of the handle and includes a driver plate fixed to a front portion of a driver holder; and
a magazine that is provided below the handle and stores staples therein,
wherein a rear portion of the handle and a rear portion of the magazine are concentrically and pivotally connected,
arms, each protruding from respective sides of the driver holder, are movably inserted into respective engaging holes formed on each of the side plates of the handle,
when the handle is initially pushed down, rear upper parts of the driver holder come in contact with an upper inner surface of the handle so that a leading end of the driver plate is inclined toward a front side of the magazine, and
when the handle is pushed down, a foremost staple in the magazine is discharged by the driver plate and binds a bunch of papers.

2. The stapler according to claim 1,
wherein lower surfaces of the engaging holes are inclined so that the arms of the driver holder are guided forward when the bunch of papers are completely bound and the handle returns upward.

3. The stapler according to claim 1,
wherein, after the leading end of the driver plate comes in contact with the foremost staple, a front upper part of the driver holder comes in contact with the upper inner surface of the handle so that the driver plate is aligned along a front wall of the magazine.

4. The stapler according to claim 1,
wherein, when the bunch of papers is completely bound, the leading end of the driver plate does not protrude from a lower surface of the magazine.

5. The stapler according to claim 4,
wherein, when the bunch of papers is completely bound, a part of the driver unit comes in contact with an upper surface of the magazine.

6. The stapler according to claim 5,
wherein the part of the driver unit includes a lower surface of the driver holder, and
the upper surface of the magazine includes upper edges of side walls of the magazine.

7. The stapler according to claim 4,
wherein, when the bunch of papers is completely bound, the driver holder engages the magazine.

8. The stapler according to claim 1,
wherein engaging portions of the driver plate are engaged with dowels formed on the driver holder, and the driver plate is fixed to the driver holder by riveting.

9. The stapler according to claim 8,
wherein the dowels are formed in pairs on respective sides of the driver holder so as to be symmetric with each other above a riveting portion of the driver holder, and the engaging portions are formed in pairs on respective sides of the driver plate so as to be symmetric with each other above the riveting portion of the driver plate.

10. The stapler according to claim 8,
wherein the engaging portions of the driver plate are arc-shaped cutout holes.

11. The stapler according to claim 1, further comprising:
a base part,
a magazine guide that has a U-shaped cross section and is fixed on an upper surface of the base part in a longitudinal direction; and
a clincher that is fixed to both side walls of the magazine guide so as to correspond to a discharge portion formed at a front end of the magazine,
wherein the rear portion of the magazine is rotatably supported on one end of the magazine guide, and
the clincher is positioned on both side walls such that longitudinal positioning means positions the clincher with respect to the longitudinal direction of the magazine guide, and such that lateral positioning means positions the clincher with respect to a lateral direction of the magazine guide.

12. The stapler according to claim 11,
wherein the longitudinal positioning means includes positioning parts that protrude from upper edges of the side walls, and engage with and end portion of the clincher in the longitudinal direction of the magazine guide.

13. The stapler according to claim 11,
wherein the longitudinal positioning means includes concave portions formed on upper edges of the side walls, and a convex portion that protrudes from a lower surface of the clincher and engages with the concave portions.

14. The stapler according to claim 11,
wherein the lateral positioning means includes protrusions that protrude from the lower surface of the clincher and engage with respective inner surfaces of the side walls.

15. The stapler according to claim 11, further comprising:
a base cover part that covers the base part,
wherein openings, through which upper edges of the side walls of the magazine guide are exposed, are formed on the base cover part.
